(19) United States
(12) Patent Application Publication
(10) Pub. No.: US 2007/0066383 A1
(43) Pub. Date: Mar. 22, 2007

(54) Gaming machine

(75) Inventors: Koichi Mori, Tokyo (JP); Nakayasu Tsukahara, Tokyo (JP); Hideaki Wada, Tokyo (JP); Kuniaki Honno, Tokyo (JP); Hiroshi Irimajiri, Tokyo (JP); Takumi Nishi, Tokyo (JP); Hiroaki Oosera, Tokyo (JP); Akio Fujita, Tokyo (JP); Yusuke Kikuchi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/390,417

(22) Filed: Mar. 28, 2006

(30) Foreign Application Priority Data
Sep. 16, 2005 (JP) 2005-270799
Oct. 31, 2005 (JP) 2005-316521

(51) Int. Cl. A63F 13/00

(52) U.S. Cl. 463/20

(57) ABSTRACT

Disclosed is a gaming machine. According to the gaming machine, when a combination of symbols relating to a winning is displayed on a one line, the symbols constituting the combination of symbols relating to the winning and symbols constituting a combination of specific symbols in accordance with the combination of symbols relating to the winning are respectively arranged on peripheries of reels so that the combination of specific symbols is displayed on a line different from the one line. In addition, an image display unit of the gaming machine displays a specific image representing a corresponding relationship between a prize in accordance with the combination of symbols relating to the winning and the combination of specific symbols in accordance with the combination of symbols relating to the winning.

### CROSS REFERENCE TO RELATED APPLICATION

This application is based upon and claims the benefit of priority from the prior Japanese Patent Applications No. 2005-270799, filed on Sep. 16, 2005, and No. 2005-316521, filed on Oct. 31, 2005, the entire contents of which are incorporated herein by reference.

### BACKGROUND OF THE INVENTION

1. Field of the Invention

The present invention relates to a gaming machine.

2. Description of Related Art

It has been known a gaming machine, so-called, pachi-slot machine having reels, each of which having symbols arranged on a periphery thereof; display windows mounted to correspond to each of the reels and displaying some of the symbols arranged on the periphery of each reel so as to allow a player to see them; a start switch for outputting a signal requiring start of rotation of each reel, based on a start operation by the player, on condition that a medal has been inserted; a stop switch for outputting a signal requiring stop of the rotation of the reel, correspondingly to types of the reels, based on a stop operation by the player; a control unit for controlling an operation of a stepping motor to rotate and stop the respective reels, based on the signals outputted from the start switch and the stop switch. In the pachi-slot machine, when the rotations of all the reels are stopped, it is determined whether a winning is achieved on the basis of a combination of symbols displayed in the display windows, and a medal is paid out, based on the determination result.

In the pachi-slot machine forming the mainstream, if the start operation by the player is detected, an internal lottery is carried out, and the rotation of reel is stopped on the basis of the lottery result and the timing of the stop operation by the player. In other words, even though a result relating to a winning is determined by the internal lottery (hereinafter, a type of the internal lottery result will be referred to as “internal winning combination”), if the stop operation is not carried out at an appropriate timing, a combination of symbols relating to the winning is not displayed. Accordingly, it is necessary for a player to have a skill, i.e., observation push.

As one of the above gaming machines, presented is a gaming machine adapted to determine whether a combination of symbols relating to a winning exists in combinations of 27 types of symbols displayed by the display windows (see Japanese Patent Laid-Open No. 2004-313447).

### SUMMARY OF THE INVENTION

However, in the above gaming machine, the combinations of 27 types of symbols can be displayed. At this time, since it is determined whether a winning is achieved with regard to each of the combinations of 27 types of symbols, a burden of the process of determining whether a winning is achieved or not is increased, and the process of paying out a medal based on the determination result may be delayed.

Accordingly, it may be considered to decrease types of the combinations of symbols, for which the process of determining whether the winning is made or not is carried out. However, if the types of combinations of symbols are decreased, the displays of combinations of symbols in which a player is interested lack diversity and thus the player's interest may be reduced.

The invention has been made to solve the above-mentioned problems occurring in the prior art. An object of the invention is to provide a gaming machine capable of reducing a burden of a process of determining whether a winning is achieved or not and preventing displays of combinations of symbols from being monotonous.

In order to achieve the above object, according to a first aspect of the invention, there is provided a gaming machine comprising: a plurality of reels, each of which having a plurality of symbols arranged on a periphery thereof; a symbol display unit having a plurality of symbol display areas for each of the reels, each of which areas displaying a symbol, and displaying some of the symbols respectively arranged on the peripheries of the reels, respectively; a start operation detection unit for detecting a start operation; an internal winning combination determination unit for determining an internal winning combination on the basis of the start operation detection carried out by the start operation detection unit; a reel rotation unit for rotating the reels, respectively; a stop operation detection unit for detecting a stop operation in accordance with types of the reels; a reel stop unit for stopping rotation of the corresponding reel when the stop operation detection is carried out by the stop operation detection unit; a winning determination unit for determining whether a winning is achieved, on the basis of a combination of symbols displayed on a one predetermined line of a plurality of lines respectively connecting one of the symbol display areas provided to each of the reels, each other, when the rotations of the reels are stopped; a unit for awarding a prize in accordance with the combination of symbols relating to the winning and displayed at the one line, to a player, when the winning is determined by the winning determination unit; and an image display unit for displaying an image related to a game, wherein when the combination of symbols relating to the winning is displayed on the one line, the symbols constituting the combination of symbols relating to the winning and symbols constituting a combination of specific symbols in accordance with the combination of symbols relating to the winning are respectively arranged on the peripheries of the reels so that the combination of specific symbols is displayed on a line different from the one line, and wherein the image display unit displays a specific image representing a corresponding relationship between the prize in accordance with the combination of symbols relating to the winning and the combination of specific symbols in accordance with the combination of symbols relating to the winning.

According to a second aspect of the invention, there is provided a gaming machine comprising: a plurality of reels, each of which having a plurality of symbols arranged on a periphery thereof; an image display unit provided just before the reels, viewing from a front side, having a plurality of symbol display areas for each of the reels, each of which areas displaying a symbol, and capable of transparently displaying some of the symbols respectively arranged on the peripheries of the reels, respectively; a start operation detection unit for detecting a start operation; an internal winning combination determination unit for determining an internal winning combination based on the start operation detection carried out by the start operation detection unit; a reel rotation unit for rotating the reels, respectively; a stop operation detection unit for detecting a stop operation in accordance with types of the reels; a reel stop unit for stopping rotation of the corresponding reel when the stop operation detection is carried out by the stop operation detection unit; a winning determination unit for determining whether a winning is achieved, on the basis of a combination of symbols displayed on a one predetermined line of a plurality of lines respectively connecting one of the symbol display areas provided to each of the reels, each other, when the rotations of the reels are stopped; and a unit for awarding a prize in accordance with the combination of symbols relating to the winning and displayed at the one line, to a player, when the winning is determined by the winning determination unit, wherein when the combination of symbols relating to the winning is displayed on the one line, the symbols constituting the combination of symbols relating to the winning and symbols constituting a combination of specific symbols in accordance with the combination of symbols relating to the winning are respectively arranged on the peripheries of the reels so that the combination of specific symbols is displayed on a line different from the one line, and wherein the image display unit displays a specific image representing a corresponding relationship between the prize in accordance with the combination of symbols relating to the winning and the combination of specific symbols in accordance with the combination of symbols relating to the winning on a neighborhood of the symbol display areas.

In the first and second aspects, when the rotations of the reels are stopped, it is determined whether a winning is achieved or not, on the basis of the combination of symbols displayed on a predetermined one line of the plurality of lines. In this case, the types of combinations of symbols, for which the process of determining whether the winning is made or not is carried out, is decreased as compared to the conventional gaming machine. Accordingly, it is possible to reduce the burden of the process relating to the determination of whether the winning is made or not, as compared to the conventional gaming machine determining whether a winning is achieved or not on the basis of combinations of symbols respectively displayed on the plurality of lines.

Further, when a combination of symbols relating to a winning is displayed on the one line, a combination of specific symbols in accordance with the combination of symbols relating to the corresponding winning is displayed on a line different from the corresponding one line. In other words, when a combination of symbols relating to a winning is displayed on a one line, a combination of specific symbols in accordance with the combination of symbols relating to the corresponding winning is displayed on another line. Accordingly, it is possible to show a player as if a prize were awarded in accordance with the combination of specific symbols which is displayed on the line different from the predetermined one line. As a result of that, displays of combinations of symbols are prevented from being monotonous so as to enhance an interest in a game.

Moreover, according to the invention, displayed is an image representing a corresponding relationship between the prize in correspondence with the combination of symbols relating to the winning and the combination of specific symbols in accordance with the combination of symbols relating to the winning. Since the player can observe the combination of specific symbols displayed on the line different from the one line and the corresponding specific image, the player can easily perceive what kind of prize will be awarded, and have a new interest.

In particular, according to the second aspect, the image display unit is provided just before the reels, viewing from a front side, and the symbols arranged on the peripheries of the reels can be transparently observed through the symbol display areas of the image display unit. An effect can be performed by displaying a predetermined image at the neighborhood of the symbol display areas in which the reels are rotated and stopped. In this structure, the specific image is displayed on the neighborhood of the corresponding symbol display area. Thereby, when a player observes the combination of specific symbols displayed on the line different from the one line and the corresponding specific image, an extent that a player's gaze moves can be reduced. Accordingly, the player's burden can be reduced and the player can perceive more easily what kind of prize will be awarded.

### BRIEF DESCRIPTION OF THE DRAWINGS

Other and further objects, features and advantages of the invention will appear more fully from the following description taken in connection with the accompanying drawings, in which:

FIG. 1 is a perspective view of schematically showing a gaming machine according to an embodiment of the invention;

FIG. 2 is a view showing a liquid crystal display unit of a liquid crystal display device provided to the gaming machine;

FIG. 3 is a perspective view of schematically showing a liquid crystal display device;

FIG. 4 is a partial exploded view of a liquid crystal display device;

FIG. 5 is a view showing an example of symbols arranged on reels provided to the gaming machine;

FIG. 6 is a block diagram of an electric circuit of the gaming machine;

FIG. 7 is block diagram of a sub-control circuit of the gaming machine;

FIG. 8 is a symbol arrangement table of the gaming machine;

FIG. 9 is a view of showing an internal lottery table determining table of the gaming machine;

FIGS. 10A and 10B show an internal lottery table of the gaming machine;

FIG. 11 is a view of showing an internal winning combination determining table;

FIG. 12 shows a reel stop initialization table of the gaming machine;

FIG. 13 is a view showing a priority ranking table of the gaming machine;

FIG. 14 is a view showing a symbol combination table of the gaming machine;

FIGS. 15A to 15E and 16A to 16G show display examples of combinations of symbols displayed on display windows of the gaming machine;

FIG. 17 shows a table on bonus operation of the gaming machine;

FIG. 18 shows an internal winning combination storing area of a RAM included in a main control circuit of the gaming machine;

FIG. 19 shows an internal carryover combination storing area of a RAM included in a main control circuit;

FIG. 20 shows a symbol storing area of a RAM included in a main control circuit;

FIG. 21 is a flow chart of a reset-intervention process carried out by a main control circuit;

FIG. 22 is a main flow chart of a bonus operation supervisory process by a main control circuit;

FIG. 23 is a flow chart showing a medal receiving and start checking process by a main control circuit;

FIG. 24 is a flow chart showing a game mode supervisory process by a main control circuit;

FIG. 25 is a flow chart showing an internal lottery process by a main control circuit;

FIG. 26 is a flow chart showing a reel stop initialization process by a main control circuit;

FIG. 27 is a flow chart showing a reel stop control process by a main control circuit;

FIG. 28 is a flow chart showing a display combination retrieving process by a main control circuit;

FIG. 29 is a flow chart showing a bonus operation checking process by a main control circuit;

FIG. 30 is a flow chart showing a bonus end checking process by a main control circuit;

FIG. 31 is a flow chart showing an intervention process having a period of 1.1173 msec by a main control circuit;

FIG. 32 is a flow chart showing a reset-intervention process by a sub-control circuit;

FIG. 33 is a flow chart showing a command receiving process carried out by a sub-control circuit;

FIG. 34 is a flow chart showing a start command corresponding process carried out by a sub-control circuit;

FIG. 35 shows a display example of a pseudo payout table displayed on a liquid crystal display device of the gaming machine; and

FIG. 36 shows another display example of a pseudo payout table displayed on a liquid crystal display device of the gaming machine.

### DESCRIPTION OF THE PREFERRED EMBODIMENTS

Hereinafter, it will be described a preferred embodiment of the present invention with reference to the drawings.

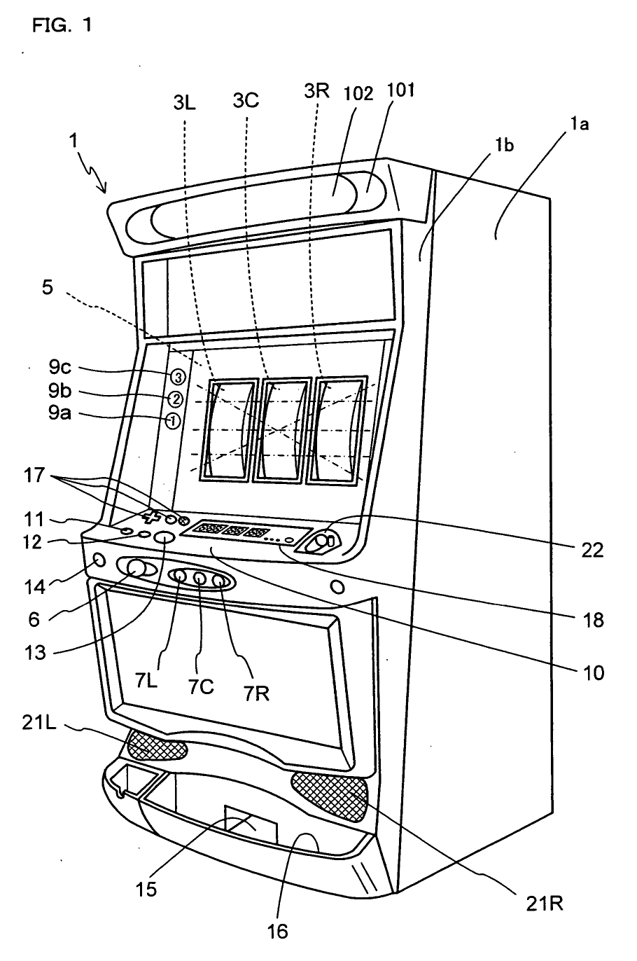

First, a gaming machine 1 according to an embodiment of the invention is schematically described with reference to FIG. 1.

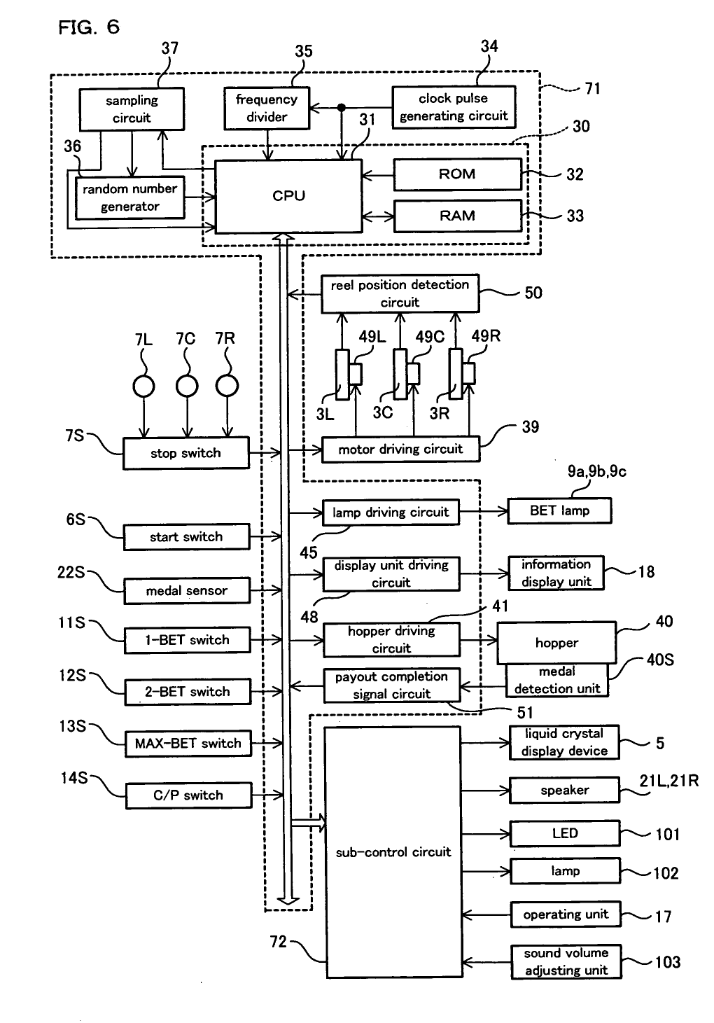

The gaming machine 1 has a cabinet la housing reels 3L, 3C, 3R, a main control circuit 71 (see FIG. 6), which will be described later, etc., and a front door 1b mounted to be opened and closed with regard to the cabinet 1a.

The three reels 3L, 3C, 3R are horizontally mounted in a row in the cabinet 1a. Symbols are continuously arranged on a periphery of each of the reels 3L, 3C, 3R in a rotation direction of the reel. Each of the reels 3L, 3C, 3R is controlled to rotate at a constant speed, for example, 80 revolutions per minute, by the main control circuit 71. The symbols arranged on the peripheries of each of the reels 3L, 3C, 3R are varied as the reel is rotated.

In a center of the front door 1b, provided is a liquid crystal display device 5 just before the reels 3L, 3C, 3R, i.e., at the front position of the reels 3L, 3C, 3R, viewing from a front side. Each of the reels 3L, 3C, 3R is adapted to be visible through a predetermined display area of the liquid crystal display device 5, which will be specifically described later. The liquid crystal display device 5 displays a predetermined image, so that information about an effect, game and the like is notified.

A control panel 10 having an approximate horizontal surface is provided below the liquid crystal display device 5. A medal insertion slot 22 for inserting a medal into the gaming machine 1 is provided to a right side of the control panel 10. Through the medal insertion slot 22, maximum 3 medals are inserted for a unit game which is, for example, a one game from after the reels start to rotate, until rotations of the reels are stopped and thus it is determined whether a privilege will be awarded or not. When one to three medals are inserted, the inserted medals are bet for a unit game. If four or more medals are continuously inserted through the medal insertion slot 22, excess medals over three are stacked, i.e., credited in the gaming machine 1. The gaming machine 1 uses a medal as a game medium. However, the game medium used in the gaming machine 1 is not limited to the medal, but a coin, a gaming ball, a token, a card storing information about an amount of the medals and the like may be applied.

A 1-BET button 11, a 2-BET button 12 and a MAX-BET button 13, which are used for determining a BET number, i.e., the number of medals bet for a unit game from the credited medals, are mounted to a left side of the control panel 10. When the 1-BET button 11 is pushed, one medal is bet from the medals credited, when the 2-BET button 12 is pushed, two medals are bet, and when the MAX-BET button 13 is pushed, three medals are bet.

To the left side of the liquid crystal display device 5 are mounted a 1-BET lamp 9a, a 2-BET lamp 9b and a MAX-BET lamp 9c. The 1-BET lamp 9a, 2-BET lamp 9b and MAX-BET lamp 9c are turned on in correspondence with the BET number. When the BET number is one, two and three, the 1-BET lamp 9a, the 2-BET lamp 9b and the MAX-BET lamp 9c are turned on, respectively.

An information display unit 18 is mounted at a center of the control panel 10. The information display unit 18 consists of 7 segment LEDs and displays the number of medals credited in the gaming machine 1, the number of medals to be paid out for a player (hereinafter, referred to as “payout number”) and the like.

An operating unit 17, which includes a cross key, a selection button and a determination button, is mounted above the BET buttons 11, 12, 13. Based on an operation of the operating unit 17 by the player, the information about a game such as game history is displayed on the liquid crystal display device 5.

A C/P button 14 for changing the credit or the payout of medals is mounted to a frontal left side of the control panel 10. When the payout is carried out, the medals as the payout number are paid out from a frontal lower medal payout slot 15 and stacked on a medal tray 16. When the credit is carried out, the medals as the payout number are credited. Herein, the payout and credit of medals may be simply referred to as “payout”.

To a right side of the C/P button 14, mounted is a start lever 6 for rotating the reels 3L, 3C, 3R.

Stop buttons 7L, 7C, 7R which are mounted to correspond to the respective reels 3L, 3C, 3R and stop the rotations of the respective reels 3L, 3C, 3R are mounted below the information display unit 18, in the frontal center of the control panel 10.

Hereinafter, a stop operation which is first carried out when all the reels 3L, 3C, 3R are rotated, i.e., a player's push operation for the stop buttons 7L, 7C, 7R, will be referred to as “first stop operation”. A stop operation which is carried out following the first stop operation when the two reels are rotated will be referred to as “second stop operation”. A stop operation which is carried out following the second stop operation when the remaining one reel is rotated will be referred to as “third stop operation”.

A LED 101 and a lamp 102 are mounted at the upper part of the front door 1b. The LED 101 and the lamp 102 emit lights with a radiation pattern in correspondence with game situations to perform an effect.

Speakers 21L, 21R are mounted at upper left and right sides of the medal tray 16. Sound such as effect sound or song is outputted in correspondence with game situations from the speakers 21L, 21R to make the game effect.

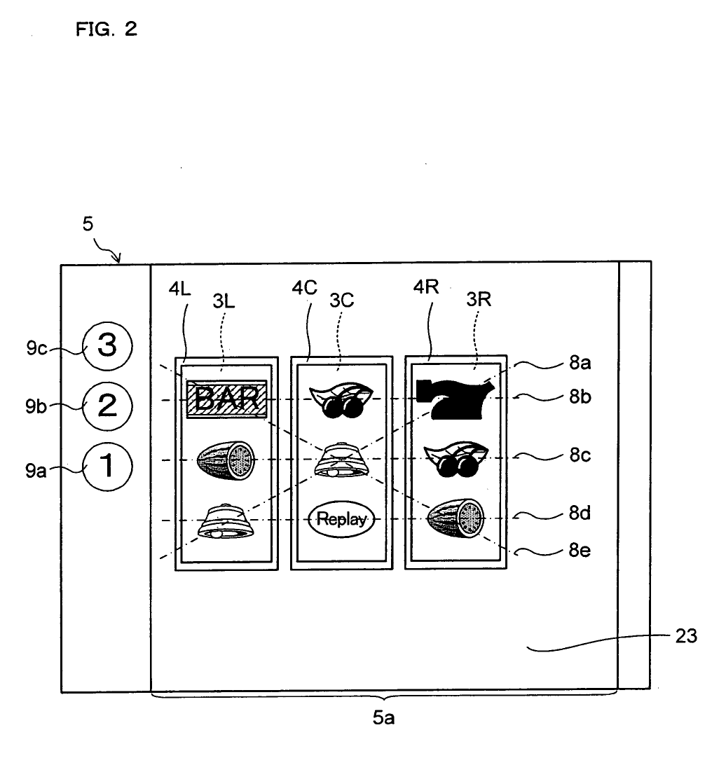

In the followings, it is described a liquid crystal display unit 5a of the liquid crystal display device 5, with reference to FIG. 2. The liquid crystal display unit 5a has symbol display areas 4L, 4C, 4R and an effect display area 23.

The symbol display areas 4L, 4C, 4R are mounted at the fronts of the corresponding reels 3L, 3C, 3R, respectively. When the symbol display areas 4L, 4C, 4R are under transparent state, the rotations of the reels 3L, 3C, 3R and stops thereof are visible. In other words, the symbol display areas 4L, 4C, 4R can transparently display the symbols arranged on the reels 3L, 3C, 3R. The transmissivity of the symbol display areas 4L, 4C, 4R is changed so that the symbol display areas 4L, 4C, 4R display an image thereon. For example, various effects are carried out by, for example, displaying an image to be overlapped over the symbols displayed when the rotations of the reels are stopped.

A one symbol is displayed in each of upper, central and lower parts of the respective symbol display areas 4L, 4C, 4R having a long rectangular shape in a longitudinal direction. Thus, 3 symbols of the symbols arranged on the periphery of the corresponding reel are displayed in each of the symbol display areas 4L, 4C, 4R. The symbol display areas 4L, 4C, 4R have a function of a so-called display window. Hereinafter, the symbol display area is sometimes referred to as “display window”.

5 lines for connecting one of the upper, central and lower parts of the respective display windows 4L, 4C, 4R each other are provided. Specifically, there are provided a top line 8b, a center line 8c, a bottom line 8d, a cross-up line 8a and a cross-down line 8e.

The center line 8c is a line connecting the central areas of the respective display windows 4L, 4C, 4R each other. The top line 8b is a line connecting the upper areas of the respective display windows 4L, 4C, 4R each other. The bottom line 8d is a line connecting the lower areas of the respective display windows 4L, 4C, 4R each other. The cross-up line 8a is a line connecting the lower area of the left display windows 4L, the central area of the center display window 4C and the upper area of the right display window 4R each other. The cross-down line 8e is a line connecting the upper area of the left display windows 4L, the central area of the center display window 4C and the lower area of the right display window 4R each other. The center line 8c is an example of a predetermined one line of the lines. The top line 8b, the bottom line 8d, the cross-up line 8a, and the cross-down line 8e are examples of lines different form the predetermined one line.

When one to three medals are inserted through the medal insertion slot 22 or the BET button 11, 12, or 13 is pushed to bet one to three medals, only the center line 8c of the five lines 8a to 8e is activated. The line activated is generally referred to as “activated line”.

The effect display area 23 is an area except the symbol display areas 4L, 4C, 4R among the display areas of the liquid display unit 5a. In the effect display area 23, a predetermined image, for example, a pseudo payout table which will be described later, is displayed to carry out an effect. An effect may be carried out by displaying a predetermined image in the entire display areas of the liquid display unit 5a including not only the effect display area 23 but also the symbol display areas 4L, 4C, 4R.

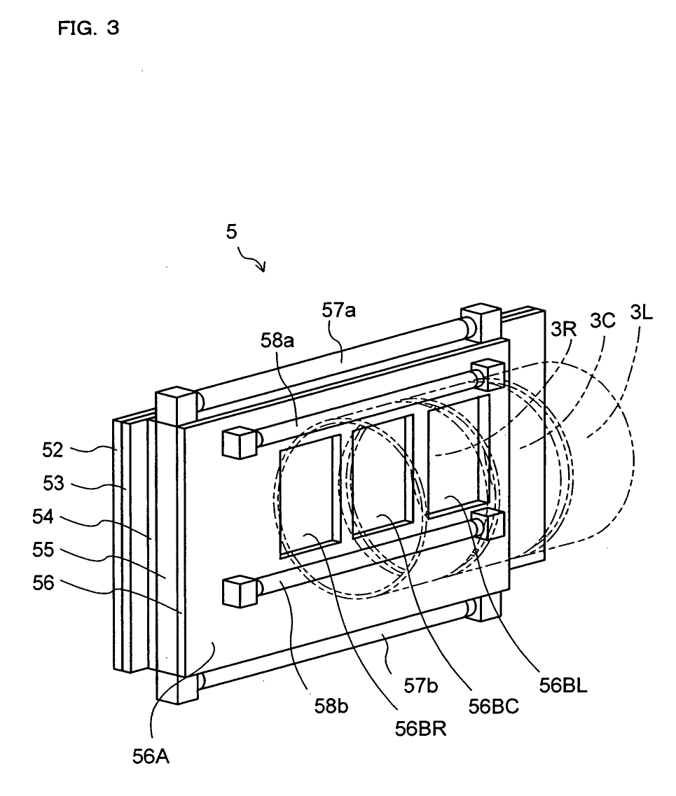

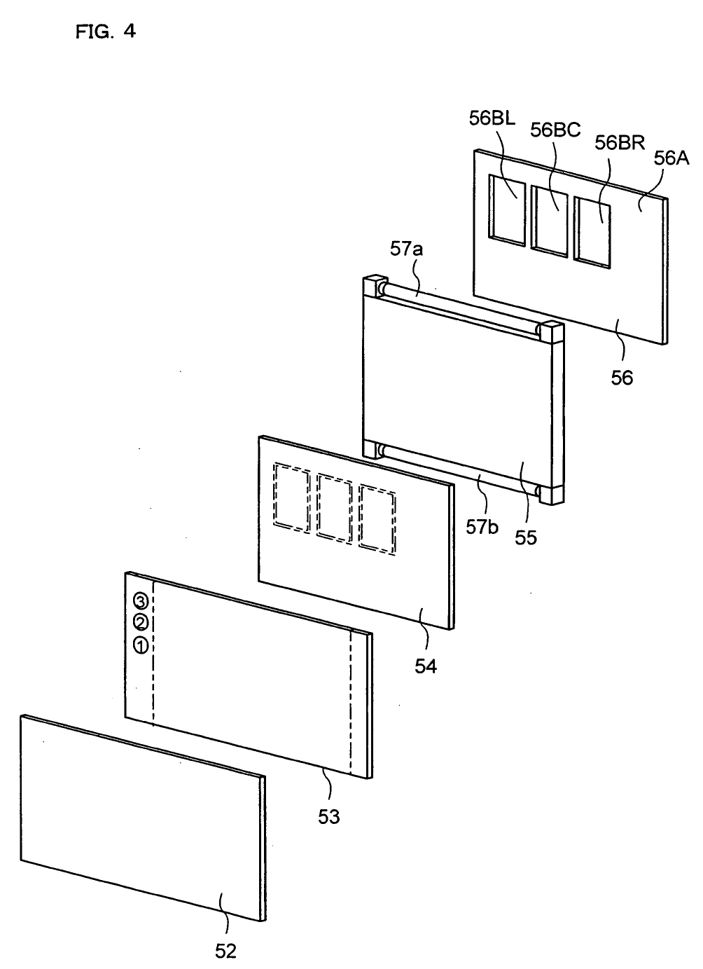

In the followings, it is described the liquid crystal display device 5 with reference to FIGS. 3 and 4. FIG. 3 is a perspective view of the liquid crystal display device 5, viewing from the rear side thereof. FIG. 4 is an exploded view of the liquid crystal display device, viewing from the front side thereof.

The liquid crystal display device 5 has a protecting glass 52, a display plate 53, a liquid crystal panel 54, a light guide plate 55, a reflecting film 56, fluorescent lamps 57a, 57b, 58a, 58b and the like. Viewing from the front side of the gaming machine 1, the liquid crystal display device 5 is mounted just before the reels 3L, 3C, 3R, i.e., mounted at the front of the reels 3L, 3C, 3R.

The protecting glass 52 and the display plate 53 include transmissive members. The protecting glass 52 is provided to observe the liquid crystal panel 54. In the liquid crystal panel 54, liquid crystals are sealingly injected in a gap between a transparent board such as glass plate having a thin film transistor layer formed thereon and a transparent board opposite to the board. A flexible board (not shown) having an IC for driving the liquid crystal panel mounted thereto is connected to a terminal unit of the liquid crystal panel 54. A display mode of the liquid crystal panel 54 is set as a normally white. The normally white means such a structure executing a white display under the state that the liquid crystal is not driven, i.e., under the state that a voltage is not applied to the liquid crystal panel 54. In this case, the light penetrates into a display surface so that the penetrated light can be visible from the exterior.

The light guide plate 55 includes a transmissive member having a light guide function, and is provided at the rear of the liquid crystal panel 54. The light guide plate 55 introduces the light from the fluorescent lamps 57a, 57b into the liquid crystal panel 54 and illuminates the liquid crystal panel 54. The reflecting film 56 is formed by forming a silver deposition film on a white polyester film or aluminum thin film, for example. The reflecting film 56 reflects the light, which is introduced into the light guide plate 55, toward the front and illuminates the liquid crystal panel 54.

The reflecting film 56 has a reflecting area 56A and non-reflecting areas, i.e., transmissive areas, 56BL, 56BC, 56BR. The non-reflecting areas 56BL, 56BC, 56BR are formed by transparent materials, so that they penetrate the incident light without reflecting it. The sizes and positions of the non-reflecting areas 56BL, 56BC, 56BR are same as those of the symbol display areas 4L, 4C, 4R.

The fluorescent lamps 57a, 57b are arranged along upper and lower ends of the light guide plate 55. The lights emitted from the fluorescent lamps 57a, 57b are introduced into the light guide plate 55. The fluorescent lamps 58a, 58b are arranged at upper and lower parts of the rear of the reflecting film 56. The lights generated from the fluorescent lamps 58a, 58b are reflected at the surfaces of the reels 3L, 3C, 3R and incident on the non-reflecting area 56BL, 56BC, 56BR. The incident lights pass through the non-reflecting area 56BL, 56BC, 56BR and illuminate the liquid crystal panel 54.

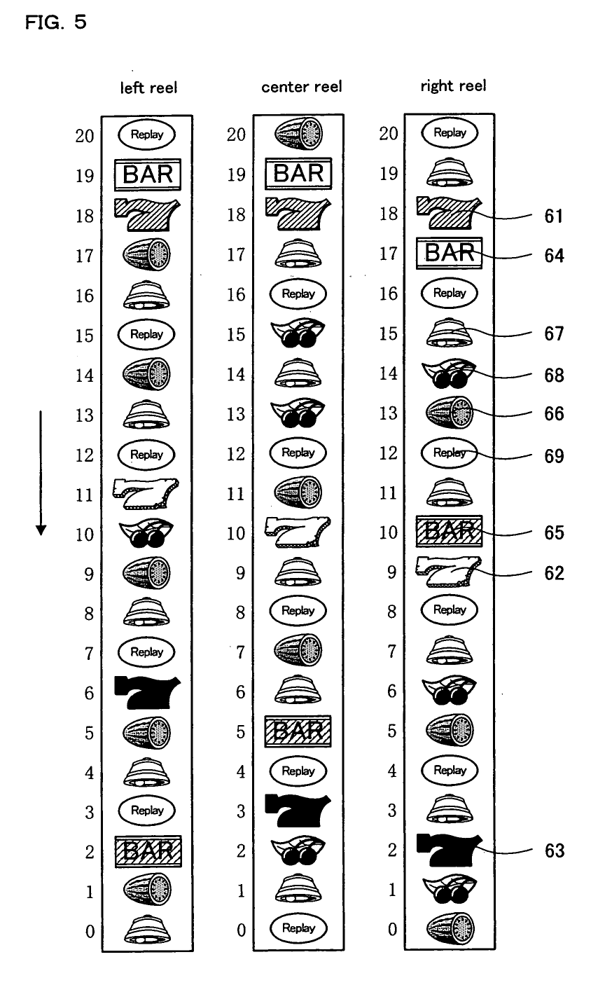

In the followings, it is described symbols arranged on the reels 3L, 3C, 3R, with reference to FIG. 5.

21 symbols are arranged on each of the reels 3L, 3C, 3R. 21 areas each being allotted with a one symbol are provided on the periphery of each of the reels 3L, 3C, 3R. Each symbol of Red 7 (symbol 61), White 7 (symbol 62), Black 7 (symbol 63), White BAR (symbol 64), Red BAR (symbol (65), Watermelon (symbol 66), Bell (symbol 67), Cherry (symbol 68) or Replay (symbol 69) is arranged on each of the corresponding areas. Each of the reels 3L, 3C, 3R is rotated in an arrow direction of FIG. 5.

In the followings, it is described a circuit structure of the gaming machine 1 having the main control circuit 71, a sub-control circuit 72 and a peripheral device (e.g., actuator) electrically connected to the main control circuit 71 or the sub-control circuit 72, with reference to FIG. 6.

The main control circuit 71 has a micro computer 30 arranged on a circuit board as a main constituting element and is further provided with a circuit for sampling random numbers. The micro computer 30 includes a CPU 31 and a ROM 32 and a RAM 33 each functioning as a memory.

To the CPU 31 is connected a clock pulse generating circuit 34, a frequency divider 35, a random number generator 36 and a sampling circuit 37. The clock pulse generating circuit 34 and the frequency divider 35 generate a reference clock pulse. Based on the generated reference clock pulse, an intervention process which will be described later is carried out. The random number generator 36 generates random numbers within a predetermined range, for example, 0 to 65535. The sampling circuit 37 extracts or samples one random number from the random numbers generated by the random number generator 36. By using the sampled random number, an internal lottery process or the like is carried out, which will be described later, and predetermined information, for example, winning number, is determined.

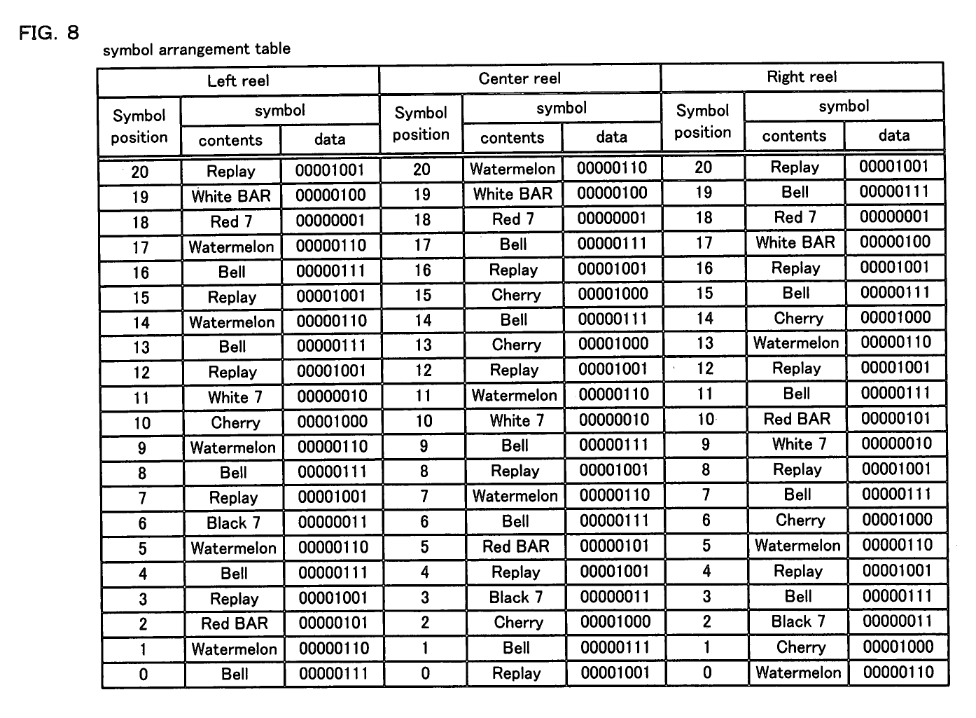

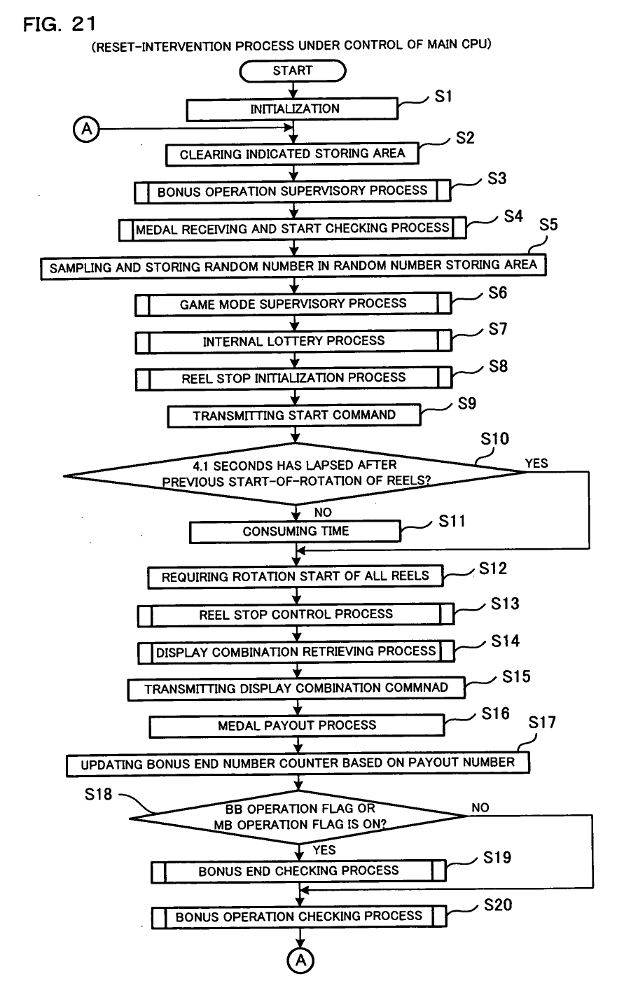

The ROM 32 of the micro computer 30 is memorized with programs relating to processes of the CPU 31 (see FIGS. 21 to 31), various tables such as internal lottery table (see FIGS. 8 to 14 and 17), and various control commands for being transmitted to the sub-control circuit 72.

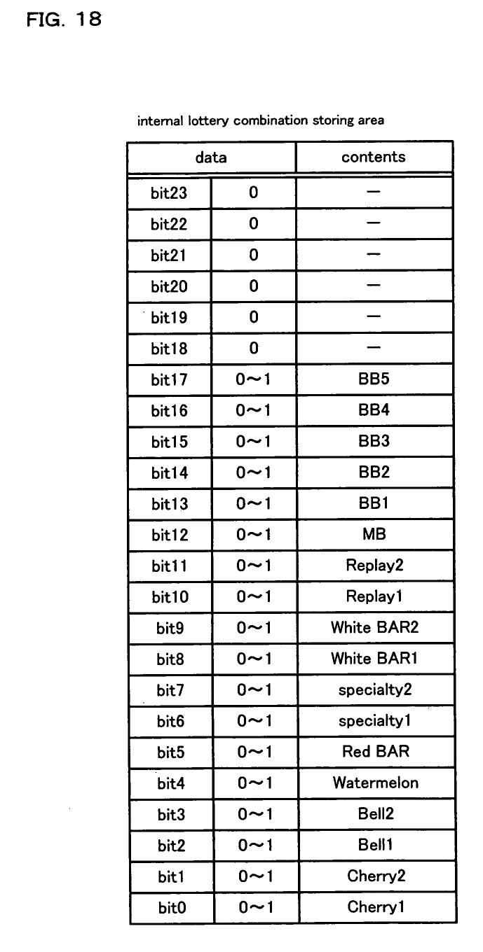

The RAM 33 stores various data obtained from the processes of the CPU 31 and, for example, has an area for storing an internal winning combination (see FIGS. 18 to 20) and the like. The data stored in the RAM 33 are transmitted to the sub-control circuit 72 by commands.

In the circuit shown in FIG. 6, main actuators controlled by a control signal from the micro computer 30 include the BET lamps 9a, 9b, 9c, an information display unit 18, a hopper 40, stepping motors 49L, 49C, 49R and the like.

To an output part of the micro computer 30, connected are circuits for receiving the control signals outputted from the CPU 31 to control the operations of the respective actuators. The circuits include a motor driving circuit 39, a lamp driving circuit 45, a display unit driving circuit 48 and a hopper driving circuit 41.

The lamp driving circuit 45 controls the driving of the BET lamps 9a, 9b, 9c, so that the BET lamps 9a, 9b, 9c are turned on or off.

The display unit driving circuit 48 controls the driving of the information display unit 18, so that various information including a credit number, etc. is displayed on the information display unit 18.

The hopper driving circuit 41 controls the driving of the hopper 40, so that the medals received in the hopper 40 are paid out.

The motor driving circuit 39 outputs the pulse coming from the main control circuit 71 to the stepping motors 49L, 49C, 49R to control the driving of the stepping motors 49L, 49C, 49R. Thereby, the reels 3L, 3C, 3R are rotated and stopped.

In this embodiment, it is counted the number of pulses outputted to the stepping motors 49L, 49C, 49R from after a reel index indicating one revolution of the reel is detected by a reel position detection circuit 50, thereby detecting a rotation angel of the reel on the basis of the detected position of the reel index. When the pulse is outputted 16 times to the stepping motors 49L, 49C, 49R, the reel is rotated as a one symbol arranged on the periphery of the reel.

More specifically, the number of pulses outputted to the stepping motors 49L, 49C, 49R is counted by a pulse counter of the RAM 33. A symbol position counter of the RAM 33 counts by one whenever 16 times of pulse outputs are counted by the pulse counter. The symbol position counter is cleared whenever the reel index is detected.

the respective symbols arranged on the periphery of the reel is defined with symbol positions “0” to “20” in regular order from the rotation direction of the reel so as to discriminate from each other. The reel index is detected by the reel position detection circuit 50 so that the symbol corresponding to the symbol position “0” is located each of center parts with respect to the longitudinal direction of the respective display windows 4L, 4C, 4R, i.e., located each part on the center line 8c.

In other words, when the value of the symbol position counter becomes “0” by the detection of the reel index, the symbol corresponding to the symbol position “0” is located on the center line 8c, so that the symbol position counter and the symbol position correspond to each other. Accordingly, by referring to the symbol counter, the symbol located on the center line 8c is specified.

In this embodiment, the symbol on the center line 8c is specified by the symbol position counter. However, the place at which a symbol is specified by the symbol position counter may be arbitrarily changed. For example, the reel index may be detected so that the symbol of the symbol position “0” is located on the top line 8b or bottom line 8d. In this case, the symbol located on the top line 8b or the bottom line 8d is specified.

To an input part of the micro computer 30, connected are a switch and the like which output predetermined signals performing the controls of the actuators. Specifically, a start switch 6S, a stop switch 7S, a 1-BET switch 11S, a 2-BET switch 12S, a MAX-BET switch 13S, a C/P switch 14S, a medal sensor 22S, the reel position detection circuit 50 and a payout completion signal circuit 51 are connected to the input part of the micro computer 30.

The start switch 6S detects an operation of the start lever 6 by the player, i.e., start operation and outputs a detected signal to the micro computer 30.

The stop switch 7S detects a push operation of the respective stop buttons 7L, 7C, 7R by the player, i.e., stop operation, and outputs a detected signal to the micro computer 30.

The 1-BET switch 11S, the 2-BET switch 12S and the MAX-BET switch 13S detect push operations of the 1-BET button 11, the 2-BET button 12 and the MAX-BET button 13 by the player, respectively, and output a detected signal to the micro computer 30.

The C/P switch 14S detects a push operation of the C/P button 14 by the player and outputs a detected signal to the micro computer 30.

The medal sensor 22S detects a medal inserted into the medal insertion slot 22 by the player and outputs a detected signal to the micro computer 30

The reel position detection circuit 50 detects the reel index indicating one revolution of the reel for each of the reels 3L, 3C, 3R and outputs a detected signal to the micro computer 30.

A medal detection unit 40S detects the number of medals paid out from the hopper 40 and inputs a detected signal to the payout completion signal circuit 51. The payout completion signal circuit 51 detects whether the number of medals paid out from the hopper 40, which is inputted from the medal detection unit 40S, reaches an indicated payout number, and outputs a detected signal to the micro computer 30.

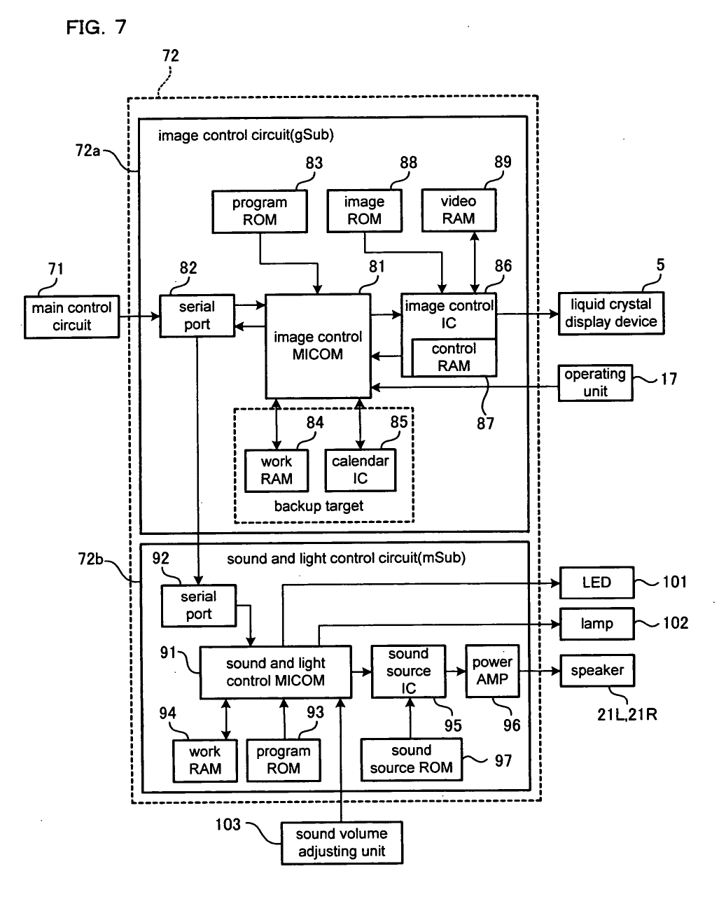

In the followings, a circuit structure of the sub-control circuit 72 is described with reference to FIG. 7.

While the main control circuit 71 controls the entire game, such as progress of game, the sub-control circuit 72 controls the effects related to a game through the display of an image and outputs of sound and light. The main control circuit 71 and the sub-control circuit 72 are electrically connected to each other by a harness or the like. The sub-control circuit 72 operates various processes, such as determination or execution of contents of effect, based on the various commands, for example, start command, transmitted from the main control circuit 71.

The sub-control circuit 72 has an image control circuit (gSub) 72a and a sound and light control circuit (mSub) 72b. The image control circuit 72a and sound and light control circuit 72b are arranged on a circuit board different from the circuit board of the main control circuit 71.

The communication of the main control circuit 71 and the image control circuit 72a is carried out in a one-way manner, from the main control circuit 71 to the image control circuit 72a. The communication of the image control circuit 72a and the sound and light control circuit 72b is carried out in a one-way manner, from the image control circuit 72a to the sound and light control circuit 72b.

The image control circuit 72a has an image control MICOM 81, a serial port 82, a program ROM 83, a work RAM 84, a calendar IC 85, an image control IC 86, a control RAM 87, an image ROM 88 and a video RAM 89.

The image control MICOM 81 has an intervention controller and an I/O port. The image control MICOM 81 determines and outputs the effect data including image information, light emission pattern information and sound information in accordance with the control programs memorized in the program ROM 83, based on the commands transmitted from the main control circuit 71. The image control circuit 72a has, likewise the main control circuit 71, a circuit for sampling random numbers, i.e., a clock pulse generating circuit, a frequency divider, a random number generator and a sampling circuit, which are connected to the image control MICOM 81 (which connection is not shown).

The serial port 82 receives a command and the like transmitted from the main control circuit 71. The program ROM 83 memorizes various programs executed in the image control MICOM 81 (see FIGS. 32 to 34), various tables and the like. The work RAM 84 serves as a temporary memory for operation when the image control MICOM 81 executes the above control programs. Various information, such as information obtained based on the various commands received from the main control circuit 71, is set in the work RAM 84.

The work RAM 84 and the calendar IC 85 are backup targets. In other words, even though the power supplied to the image control MICOM 81 is cutoff, the power is continuously supplied to them, so that the memorized information is not erased.

The operating unit 17 is connected to the image control MICOM 81. For example, when the operating unit 17 is operated by the player, the information such as game history is outputted to the liquid crystal display device 5.

The image control IC 86 produces and outputs an image in correspondence with the effect data determined by the image control MICOM 81, for example, effect data in correspondence with a pseudo payout table which will be described later, to the liquid crystal display device 5. The control RAM 87 is included in the image control IC 86. The image control MICOM 81 carries out a process of writing or reading the information and the like to and from the control RAM 87. The control RAM 87 is developed with a register, a sprite attribute table and a color palette of the image control IC 86 (which development is not shown). The image control MICOM 81 updates the register and the sprite attribute table of the image control IC 86 at every timing predetermined.

The image control IC 86 is connected with the liquid crystal display device 5, the image ROM 88 and the video RAM 89. The image ROM 88 may be connected to the image control MICOM 81. This case may be advantageous because mass image data such as three dimensional image data, etc. can be processed.

The image ROM 88 memorizes image data for producing an image, dot data and the like. For example, the image ROM 88 memorizes sprite image data of character such as person or animal, sprite image data of sign, letter, figure and the like, background image data, etc. The sprite image is displayed to be overlapped over the background image.

The video RAM 89 serves as a temporary memory when the image control IC 86 produces an image. The image control IC 86 transmits a signal to the image control MICOM 81 whenever the data transmission of the video RAM 89 to the liquid crystal display device 5 is completed.

In the sub-control circuit 72, the image control MICOM 81 carries out the control of the sound and light effects, too. The image control MICOM 81 determines types and output timing of the sound and light based on the effect data determined. The image control MICOM 81 transmits a command to the sound and light control circuit 72b via the serial port 82 at every timing predetermined.

The sound and light control circuit 72b has a sound and light control MICOM 91, a serial port 92, a program ROM 93, a work RAM 94, a sound source IC 95, a power AMP 96 and a sound source ROM 97.

The serial port 92 receives the command and the like which is transmitted from the image control circuit 72a. The program ROM 93 memorizes a control program and the like which is executed in the sound and light control MICOM 91. The work RAM 94 serves as a temporary memory for operation when the sound and light control MICOM 81 executes the above control program.

The sound and light control MICOM 91 has a CPU, an intervention controller and an I/O port. The sound and light control MICOM 91 outputs the command transmitted from the image control circuit 72a to the speakers 21L, 21R, the LED 101 and the lamp 102 according to the control program memorized in the program RAM 93.

The sound source IC 95 produces a sound source based on the command transmitted from the image control circuit 72a, and outputs the produced sound source to the power AMP 96. The power AMP 96 is an amplifier and connected with the speakers 21L, 21R. The power AMP 96 amplifies the sound source outputted from the sound source IC 95, and outputs the amplified sound source from the speakers 21L, 21R. The sound source ROM 97 memorizes sound source data including a phrase, etc. for producing the sound source. To the sound and light control MICOM 91, connected is a sound volume adjusting unit 103. When an operator in a hall operates the sound volume adjusting unit 103, the sound volume outputted from the speakers 21L, 21R is adjusted.

In the followings, a symbol arrangement table is described with reference to FIG. 8.

The symbol arrangement table shows the symbols arranged on the peripheries of the reels 3L, 3C, 3R, as data. In other words, the symbol arrangement table defines Red 7, White 7, Black 7, White BAR, Red BAR, Watermelon, Bell, Cherry, and Replay symbols in the same arrangement as FIG. 5. A type of each symbol is represented by 1 byte data, as shown. For example, the data representing Red 7 is “00000001”, i.e., “1”, and the data representing Replay is “00001001”, i.e., “9”.

With the symbols located on the center line 8c when the reel index is detected being defined as the symbol position “0”, the symbol arrangement table defines the symbol positions “0” to “20” corresponding to the respective values of the symbol position counter and types of symbols corresponding to the respective symbol positions. Accordingly, based on the symbol arrangement table and the value of the symbol position counter, symbols of the respective reels 3L, 3C, 3R on the center line 8c can be specified. For example, when the value of the symbol position counter of the right reel 3R is “18”, it is specified that Red 7 (symbol 61) of the symbol position “18” of the right reel 3R is located on the center part of the right reel 3R. In addition, by referring to the symbol position counter and the symbol arrangement table, not only symbols located on the center line 8c but also symbols adjacent to the symbols on the center line 8c are determined.

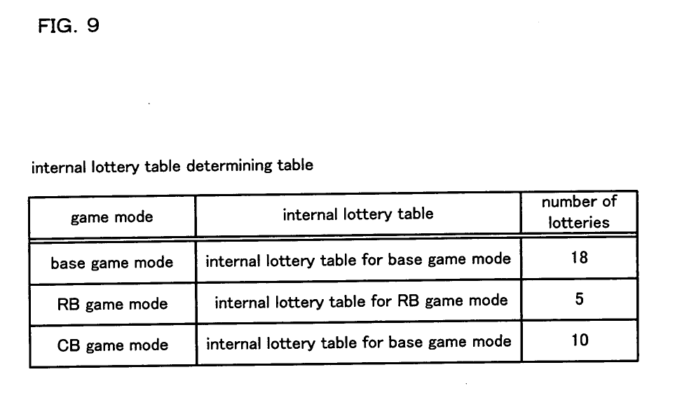

In the followings, an internal lottery table determining table is described with reference to FIG. 9.

The internal lottery table determining table defines a type of an internal lottery table and the number of lotteries which are determined in correspondence with a game mode. In a base game mode, an internal lottery table for a base game mode is determined to be used and the number of lotteries is basically determined to be 18. In a regular bonus (hereinafter, abbreviated as “RB”) game mode, an internal lottery table for a RB game mode is determined to be used and the number of lotteries is determined to be 5. In a challenge bonus (hereinafter, abbreviated as “CB”) game mode, an internal lottery table for a CB game mode is determined to be used and the number of lotteries is determined to be 10.

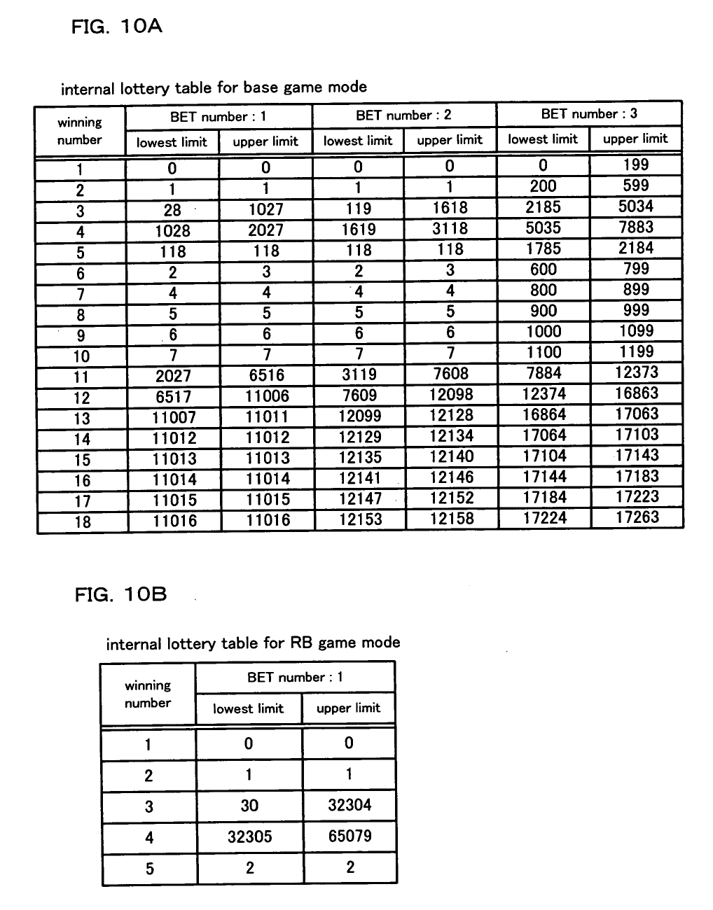

In the followings, an internal lottery table is described with reference to FIGS. 10A and 10B.

The internal lottery table defines the lowest and upper limits of random numbers, i.e., the ranges of random numbers allotted to respective winning numbers. The winning number is used to determine an internal winning combination on the basis of an internal winning combination determining table which will be described later.

Based on the internal lottery table, searched is in which range of random numbers the random number sampled from the range of “0 to 65535” is included, in descending power of the winning numbers. When the sampled random number is included between the lowest limit and the upper limit, a corresponding winning number is determined. The number of lotteries indicates the number of the above searches. As a result of performing the searches as the number of lotteries, when the sampled random number dose not correspond to any winning number, the winning number 0 which indicates “losing” is determined.

FIG. 10A shows an internal lottery table for a base game mode. In the internal lottery table for a base game mode, the lowest and upper limits of the random number, i.e., the ranges of random numbers allotted to respective winning numbers 1 to 18 are defined in correspondence with the BET numbers 1 to 3. A winning probability of each winning number is calculated by “(1+difference between the lowest and upper limits defined for each winning number)/(the number of all random numbers occurring, i.e., 65536)”. In the internal lottery table for the normal game mode, the greater the BET number, the higher the winning probability by stages.

FIG. 10B shows an internal lottery table for a RB game mode. In the RB game mode, the maximum BET number is determined to be 1. Accordingly, in the internal lottery table for the RB game mode, the lowest and upper limits corresponding to each of the winning numbers 1 to 5 are defined with regard to the BET number 1 only. In the internal lottery table for the RB game mode, the winning probabilities of the winning number 3 which indicates “Bell 1” described later and the winning number 4 which indicates “Bell 2” described later are very high.

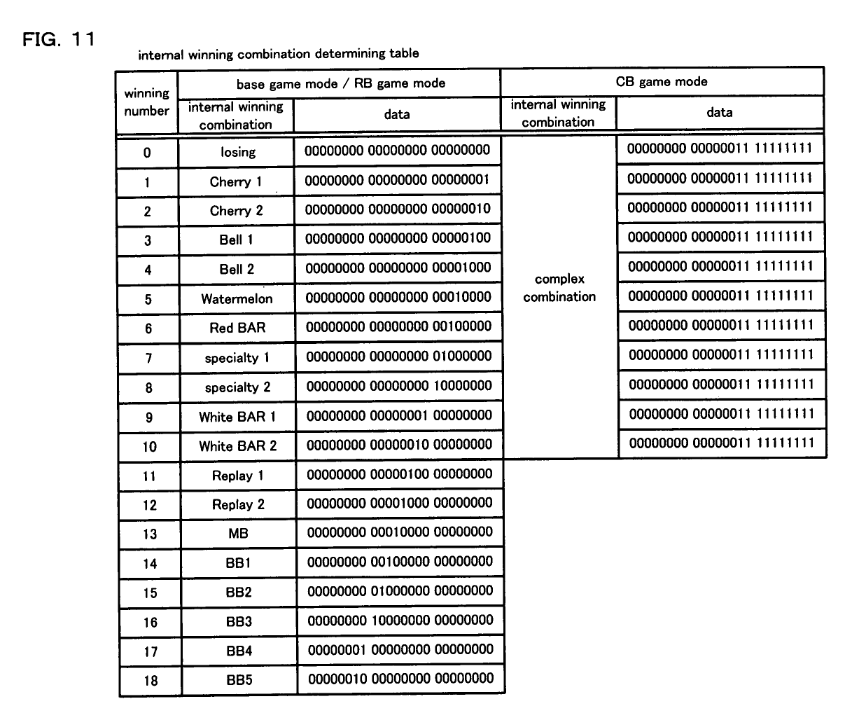

In the followings, an internal winning combination determining table is described with reference to FIG. 11.

The internal winning combination determining table defines internal winning combinations respectively corresponding with the winning numbers. Specifically, in the base game mode or RB game mode, each of losing, Cherry 1, Cherry 2, Bell 1, Bell 2, Watermelon, Red BAR, Specialty 1, Specialty 2, White BAR 1, White BAR 2, Replay 1, Replay 2, Middle Bonus (hereinafter, abbreviated as “MB”), Big Bonus (hereinafter, abbreviated as “BB”) 1, BB2, BB3, BB4 and BB5, is defined in correspondence with each of the winning numbers 0 to 18. Each internal winning combination is expressed by 3 bytes data as shown, and a bit corresponding to the type of the internal winning combination is ON. For example, in the data representing Cherry 1, a bit 0 is ON, and in the data representing BB5, a bit 17 is ON.

In the CB game mode, a complex combination is commonly defined in each of the winning numbers 0 to 10. In other words, in the CB game mode, irrespective of the type of the winning number determined, i.e., irrespective of the lottery result by the internal lottery table, a complex combination is determined as an internal winning combination without fail. In the data representing the complex combination, bits 0 to 9 are all ON. Accordingly, the determination of the complex combination is identical to a case that all of Cherry 1, Cherry 2, Bell 1, Bell 2, Watermelon, Red BAR, Specialty 1, Specialty 2, White BAR 1 and White BAR 2 are determined. In this case, a combination of symbols relating to one of Cherry 1, Cherry 2, Bell 1, Bell 2, Watermelon, Red BAR, Specialty 1, Specialty 2, White BAR 1 and White BAR 2 is displayed on the activated line.

Like this, when a winning number is determined by the internal lottery table, an internal winning combination is determined in correspondence with the corresponding winning number. Accordingly, the determination of the winning number is equivalent to the determination of the internal winning combination.

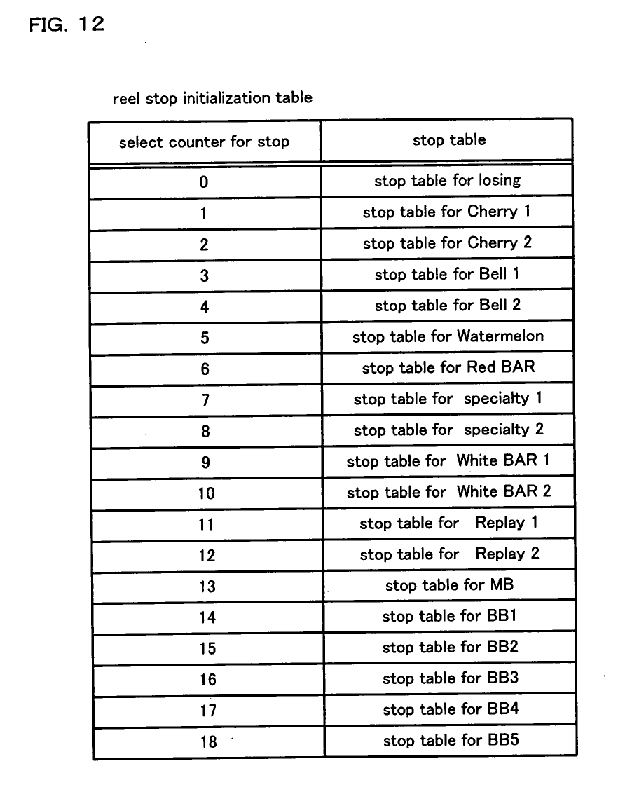

In the followings, a reel stop initialization table it is described with reference to FIG. 12.

The reel stop initialization table defines types of a stop table in correspondence with respective values of a select counter for stop. The select counter for stop stores a value which is used to determine a stop table and is basically identical to the winning number. Specifically, in accordance with values “0 to 18” of the select counter for stop, defined are stop tables corresponding to each of losing, Cherry 1, Cherry 2, Bell 1, Bell 2, Watermelon, Red BAR, Specialty 1, Specialty 2, White BAR 1, White BAR 2, Replay 1, Replay 2, MB, BB1, BB2, BB3, BB4 and BB5.

In the stop tables, defined are combinations of symbols which may be displayed on the display windows 4L, 4C, 4R. Specifically, the stop table defines the number of sliding symbols in accordance with the symbol position (i.e., a symbol position from which the rotation of reel starts to be stopped, and referred to as “stop starting position”) corresponding to the value of the symbol position counter of a corresponding reel when the stop operation through the stop switch 7S is detected. For example, according to a stop table for Bell 1, the number of sliding symbols is defined for each of the symbol positions so that a combination of symbols relating to Bell 1, i.e., “Bell-Bell-Bell”, is displayed on the activated line.

The number of sliding symbols is the number of symbols passing through the center line 8c, from after the stop operation through the stop switch 7S is detected until the rotation of the corresponding reel is stopped. The number of sliding symbols is perceived by the value of the symbol position counter updated from after the stop operation through the stop switch 7S is detected. According to the gaming machine 1, in the base game mode, after a signal is outputted by the stop switch 7S, a control for stopping the rotations of the reels 3L, 3C, 3R is carried out within 190 msec. The number of sliding symbols is set as the maximum “4”.

For example, if the stop starting position is “0” and the number of sliding symbols determined is “4”, the rotation of reel is stopped so that a symbol of the symbol position “4” is displayed on the center line 8c. Like this, the control for stopping the rotation of reel is referred to as “attraction-in”, which allows the symbols within a range of the maximum number of sliding symbols from the stop starting position to be displayed on the center line 8c. The position of the symbol which is attracted-in as the number of sliding symbols from the stop starting position and then stopped is referred to as “expected stop position”. In the above case, the expected stop position is “4”.

In the CB game mode, the rotation of the left reel 3L of the three reels 3L, 3C, 3R is stopped, when the signal is outputted by the stop switch 7S, within 75 msec so that the number of sliding symbols with regard to the left reel 3L is set as the maximum “1”. On the other hand, with regard to the center reel 3C and the right reel 3R, the number of sliding symbols is set as the maximum “4”, likewise the base game mode.

As a result of that, in the CB game mode, since the number of symbols which can be attracted-in is reduced as compared to the base game mode, it is required for the player to have a higher skill regarding the stop operation. However, as described above, in the CB game mode, since the complex combination is, without fail, determined as an internal winning combination, a combination of symbols relating to one of Cherry 1, Cherry 2, Bell 1, Bell 2, Watermelon, Red BAR, Specialty 1, Specialty 2, White BAR 1 and White BAR 2 is displayed on the center line 8c, depending on the timing of the stop operation. Accordingly, in the CB game mode, although it is required for the player to have a higher skill as compared to the other game modes, a desired winning can be achieved depending on the skill and thus the player's interest can be increased.

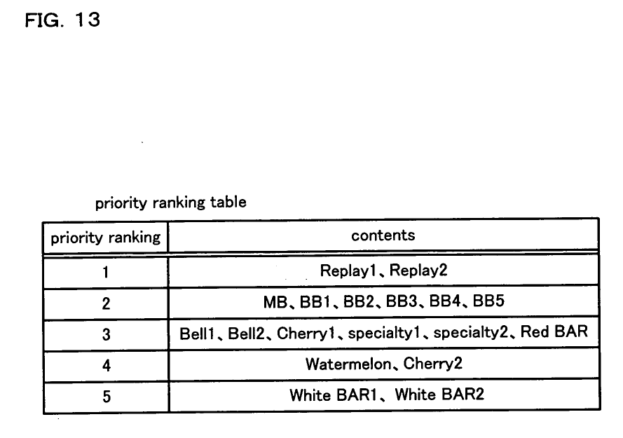

In the followings, a priority ranking table is described with reference to FIG. 13.

The priority ranking table defines a priority ranking in which the attraction-in is preferentially carried out regarding the types of the internal winning combination or types of symbol. In the table, the priority rankings 1 to 5 are defined in correspondence with the types of the internal winning combination. Specifically, it is defined “Replay 1, Replay 2”, “MB, BB1, BB2, BB3, BB4, BB5”, “Bell 1, Bell 2, Cherry 1, Specialty 1, Specialty 2, Red BAR”, “Watermelon, Cherry 2”, and “White BAR1, White BAR2” in order of the priority rankings 1 to 5. Thereby, when two or more types of internal winning combinations are determined, it is determined which of the internal winning combinations has priority. For example, when a winning number 3 indicating “Bell 1” is determined with BB1 being carried over, the stop table for Bell 1 is basically determined. However, the attraction-in of the symbols relating to BB 1 having the higher priority ranking is preferentially carried out.

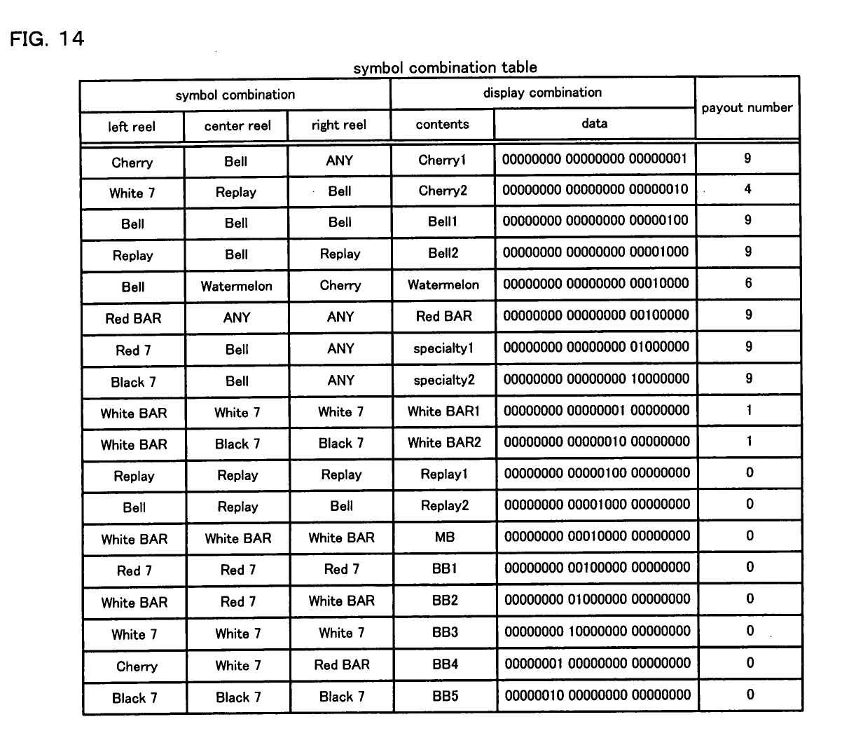

In the priority ranking table, except “Replay1, Replay 2” of the priority ranking 1, the priority rankings are defined in order of the greater privileges which are awarded to the player (see FIG. 14). Thereby, it is prevented payouts which should be obtained by the player from being lost. The combinations having the same magnitude of privilege are grouped and are given with one priority ranking. Thereby, it is possible to reduce the values capable of being adopted as the priority ranking and to reduce the data capacity, as compared to the case that the priority ranking is defined in each of the internal winning combinations. In the CB game mode, a dedicated priority ranking table may be provided. In the priority ranking table for the CB game mode, Cherry 1, Cherry 2, Bell 1, Bell 2, Watermelon, Red BAR, Specialty 1, Specialty 2, White BAR 1 and White BAR 2 may be grouped and then given with the same one priority ranking.

In the followings, a symbol combination table is described with reference to FIG. 14.

The symbol combination table defines a combination of symbols relating to a privilege awarding and a display combination and a payout number corresponding to it. The display combination is expressed by 3 bytes data, likewise the data representing the internal winning combination. For example, in the data representing the BB5, a bit 17 is ON.

If the combination of symbols relating to Cherry 1, i.e., “Cherry-Bell-ANY (“ANY” means any symbol)” is displayed on the center line 8c, a display combination is determined as Cherry 1. In other words, if Cherry symbol on the center reel 3c is displayed in the center part of the left display window 4L, and Bell symbol on the center reel 3C is displayed in the center part of the center display window 4C, a display combination is determined as Cherry 1, irrespective of the type of symbol displayed on the other right display windows 4R. Then, the payout number is determined to be 9.

If the combination of symbols relating to Cherry 2, i.e., “White 7-Replay-Bell” is displayed on the center line 8c, a display combination is determined as Cherry 2. In other words, if White 7 symbol on the left reel 3L, Replay symbol on the center reel 3C and Bell symbol on the right reel 3R are respectively displayed in the center parts of the display windows 4L, 4C, 4R, a display combination is determined as Cherry 2. Then, the payout number is determined to be 4.

If the combination of symbols relating to Bell 1, i.e., “Bell-Bell-Bell” is displayed on the center line 8c, a display combination is determined as Bell 1. In other words, if Bell symbols on the reels 3L, 3C, 3R are respectively displayed in the center parts of the display windows 4L, 4C, 4R, a display combination is determined as Bell 1. Then, the payout number is determined to be 9.

If the combination of symbols relating to Bell 2, i.e., “Replay-Bell-Replay” is displayed on the center line 8c, a display combination is determined as Bell 2. In other words, if Replay symbol on the left reel 3L, Bell symbol on the center reel 3C, and Replay symbol on the right reel 3R are respectively displayed in the center parts of the display windows 4L, 4C, 4R, a display combination is determined as Bell 2. Then, the payout number is determined to be 9.

If the combination of symbols relating to Watermelon, i.e., “Bell-Watermelon-Cherry” is displayed on the center line 8c, a display combination is determined as Watermelon. In other words, if Bell symbol on the left reel 3L, Watermelon symbol on the center reel 3C, and Cherry symbol on the right reel 3R are respectively displayed in the center parts of the display windows 4L, 4C, 4R, a display combination is determined as Watermelon. Then, the payout number is determined to be 6.

If the combination of symbols relating to Red BAR, i.e., “Red BAR-ANY-ANY” is displayed on the center line 8c, a display combination is determined as Red BAR. In other words, if Red BAR symbol on the left reel 3L is displayed in the center part of the left display window 4L, a display combination is determined as Red BAR, irrespective of types of symbols displayed on the center display window 4C and the right display window 4R. Then, the payout number is determined to be 9.

If the combination of symbols relating to Specialty 1, i.e., “Red 7-Bell-ANY” is displayed on the center line 8c, a display combination is determined as Specialty 1. In other words, if Red 7 symbol on the left reel 3L is displayed in the center part of the left display window 4L, and Bell symbol on the center reel 3C is displayed in the center part of the center display window 4C, a display combination is determined as Specialty 1, irrespective of type of symbol displayed in the center part of the other right reel 4R. Then, the payout number is determined to be 9.

If the combination of symbols relating to Specialty 2, i.e., “Black 7-Bell-ANY” is displayed on the center line 8c, a display combination is determined as Specialty 2. In other words, if Black 7 symbol on the left reel 3L is displayed in the center part of the left display window 4L, and Bell symbol on the center reel 3C is displayed in the center part of the center display window 4C, a display combination is determined as Specialty 2, irrespective of type of symbol displayed in the center part of the other right reel 4R. Then, the payout number is determined to be 9.

If the combination of symbols relating to White BAR1, i.e., “White BAR-White 7-White 7” is displayed on the center line 8c, a display combination is determined as White BAR1. In other words, if White BAR symbol on the left reel 3L, White 7 symbol on the center reel 3C and White 7 symbol on the right reel 3R are respectively displayed in the center parts of the display windows 4L, 4C, 4R, a display combination is determined as White BAR1. Then, the payout number is determined to be 1.

If the combination of symbols relating to White BAR2, i.e., “White BAR-Black 7-Black 7” is displayed on the center line 8c, a display combination is determined as White BAR2. In other words, if White BAR symbol on the left reel 3L, Black 7 symbol on the center reel 3C and Black 7 symbol on the right reel 3R are respectively displayed in the center parts of the display windows 4L, 4C, 4R, a display combination is determined as White BAR2. Then, the payout number is determined to be 1.

If the combination of symbols relating to Replay1, i.e., “Replay-Replay-Replay” is displayed on the center line 8c, a display combination is determined as Replay1. In other words, if Replay symbols on the reels 3L, 3C, 3R are respectively displayed in the center parts of the display windows 4L, 4C, 4R, a display combination is determined as Replay1.

If the combination of symbols relating to Replay2, i.e., “Bell-Replay-Bell” is displayed on the center line 8c, a display combination is determined as Replay2. In other words, if Bell symbol on the left reel 3L, Replay symbol on the center reel 3C and Bell symbol on the right reel 3R are respectively displayed in the center parts of the display windows 4L, 4C, 4R, a display combination is determined as Replay2.

When Replay1 or Replay 2 is determined, the game is replayed in a next unit game. More specifically, the same number of medals as the BET number in the unit game in which Replay has been achieved is automatically bet for the next unit game without consuming the medal and without the BET operation by the player.

If the combination of symbols relating to MB, i.e., “White BAR-White BAR-White BAR” is displayed on the center line 8c, a display combination is determined as MB. In other words, if White BAR symbols on the reels 3L, 3C, 3R are respectively displayed in the center parts of the display windows 4L, 4C, 4R, a display combination is determined as MB. When MB is determined, a MB operation flag is set to ON and MB starts to operate.

If the combination of symbols relating to BB1, i.e., “Red 7-Red 7-Red 7” is displayed on the center line 8c, a display combination is determined as BB1. In other words, if Red 7 symbols on the reels 3L, 3C, 3R are respectively displayed in the center parts of the display windows 4L, 4C, 4R, a display combination is determined as BB1.

If the combination of symbols relating to BB2, i.e., “White BAR-Red 7-White BAR” is displayed on the center line 8c, a display combination is determined as BB2. In other words, if White BAR symbol on the left reel 3L, Red 7 symbol on the center reel 3C and White BAR symbol on the right reel 3R are respectively displayed in the center parts of the display windows 4L, 4C, 4R, a display combination is determined as BB2.

If the combination of symbols relating to BB3, i.e., “White 7-White 7-White 7” is displayed on the center line 8c, a display combination is determined as BB3. In other words, if White 7 symbols on the reels 3L, 3C, 3R are respectively displayed in the &enter parts of the display windows 4L, 4C, 4R, a display combination is determined as BB3.

If the combination of symbols relating to BB4, i.e.,“Cherry-White 7-Red BAR” is displayed on the center line 8c, a display combination is determined as BB4. In other words, if Cherry symbol on the left reel 3L, White 7 symbol on the center reel 3C and Red BAR symbol on the right reel 3R are respectively displayed in the center parts of the display windows 4L, 4C, 4R, a display combination is determined as BB4.

If the combination of symbols relating to BB5, i.e., “Black 7-Black 7-Black 7” is displayed on the center line 8c, a display combination is determined as BB5. In other words, if Black 7 symbols on the reels 3L, 3C, 3R are respectively displayed in the center parts of the display windows 4L, 4C, 4R, a display combination is determined as BB5.

When BB1, BB2M BB3, BB4 or BB5 (which are sometimes generically referred to as “BB”) is determined, a BB operation flag is set to ON and BB starts to operate.

If another combination of symbols, which is different from the combinations of symbols relating to the winning defined in the symbol combination table, i.e., the combinations of symbols relating to each of Cherry 1, Cherry 2, Bell 1, Bell 2, Watermelon, Red BAR, Specialty 1, Specialty 2, White BAR1, White BAR2, Replay 1, Replay 2, MB, BB1, BB2, BB3, BB4 and BB5, is displayed on the center line 8c, the display combination is determined as losing. Cherry 1, Cherry 2, Bell 1, Bell 2, Watermelon, Red BAR, Specialty 1, Specialty 2, White BAR1 and White BAR2 relate to the payout of the game medium such as medal. Replay 1 and Replay 2 relate to a replay of the game. MB, BB1, BB2, BB3, BB4 and BB5 relate to an operation of a game mode advantageous to the player, for example, CB game mode or RB game mode.

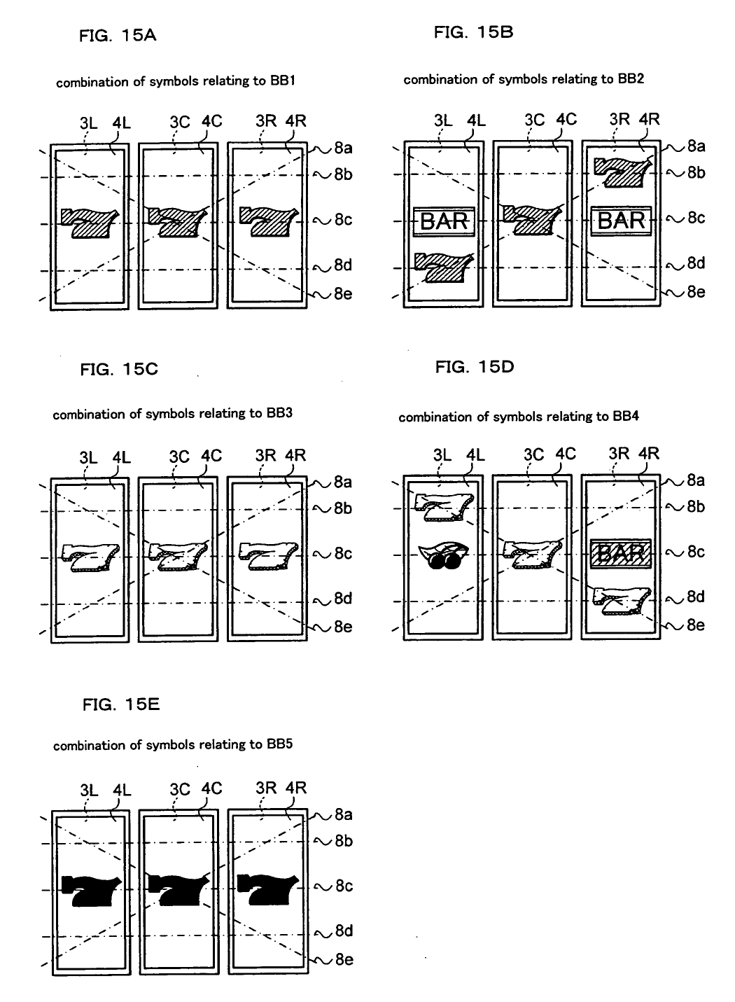

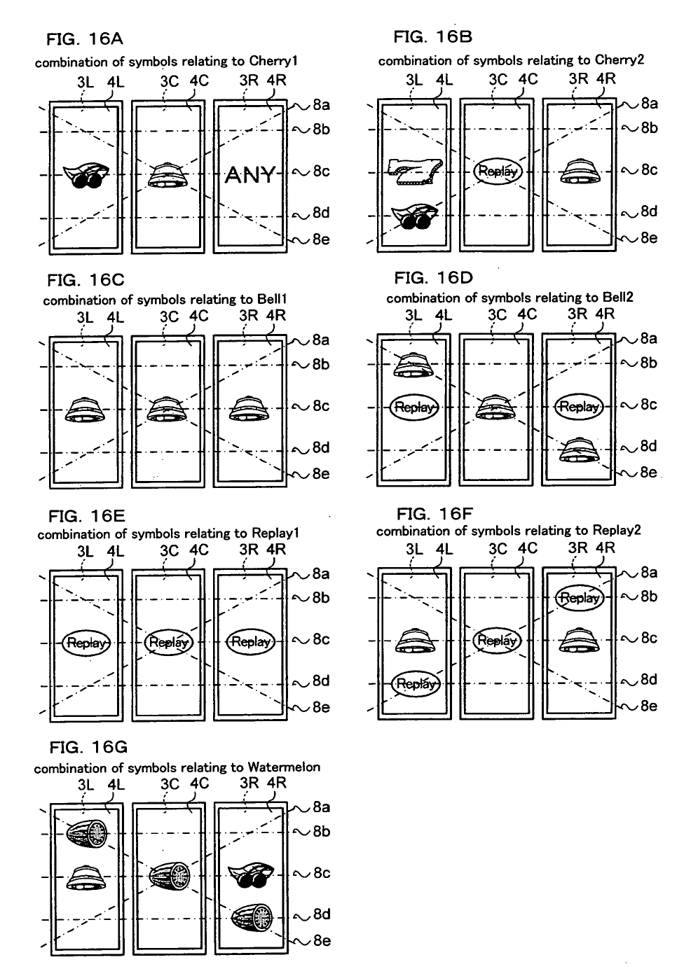

In the followings, it is described display examples of combinations of symbols relating to BB1, BB2, BB3, BB4 and BB5, with reference to FIGS. 15A to 15E. In addition, it is described display examples of combinations of symbols relating to each of Cherry 1, Cherry 2, Bell 1, Bell 2, Replay 1, Replay 2 and Watermelon, with reference to FIGS. 16A to 16G.

FIG. 15A shows a display example where a combination of symbols relating to BB1, i.e., “Red 7-Red7-Red 7”, is displayed on the center line 8c. In other words, it is shown that Red 7 symbols are displayed on the center line 8c in order.

FIG. 15B shows a display example where a combination of symbols relating to BB2, i.e.,“White BAR-Red7-White BAR”, is displayed on the center line 8c. On the periphery of the left reel 3L, Red 7 symbol is arranged at the one symbol position below White BAR symbol (see FIG. 5). On the periphery of the right reel 3R, Red 7 symbol is arranged at the one symbol position above White BAR symbol. Accordingly, White BAR symbol on the left reel 3L, Red 7 symbol on the center reel 3C and White BAR symbol on the right reel 3R are respectively displayed in the center parts of the display windows 4L, 4C, 4R, so that a combination of symbols, in which three Red 7 symbols are arranged on the cross-up line 8a, is displayed. Therefore, it is possible to show the player as if BB2 were determined as three Red 7 symbols are arranged on the cross-up line 8a which is a non-activated line.

FIG. 15C shows a display example where a combination of symbols relating to BB3, i.e., “White 7-White 7-White 7”, is displayed on the center line 8c. In other words, it is shown that White 7 symbols are displayed on the center line 8c in order.

FIG. 15D shows a display example where a combination of symbols relating to BB4, i.e., “Cherry-White 7-Red BAR”, is displayed on the center line 8c. On the periphery of the left reel 3L, White 7 symbol is arranged at the one symbol position above Cherry symbol. On the periphery of the right reel 3R, White 7 symbol is arranged at the one symbol position below Red BAR symbol. Accordingly, Cherry symbol on the left reel 3L, White 7 symbol on the center reel 3C and Red BAR symbol on the right reel 3R are respectively displayed in the center parts of the display windows 4L, 4C, 4R, so that a combination of symbols in which three White 7 symbols are arranged is displayed on the cross-down line 8e. Therefore, it is possible to show the player as if BB4 were operated as three White 7 symbols are arranged on the cross-down line 8e which is a non-activated line.

FIG. 15E shows a display example where a combination of symbols relating to BB5, i.e., “Black 7-Black 7-Black 7”, is displayed on the center line 8c. In other words, it is shown that Black 7 symbols are displayed on the center line 8c in order.

FIG. 16A shows a display example where a combination of symbols relating to Cherry 1, i.e., “Cherry-Bell-ANY”, is displayed on the center line 8c. In other words, it is shown that Cherry symbol on the left reel 3L is displayed in the center part of the left display window 4L.

FIG. 16B shows a display example where a combination of symbols relating to Cherry 2, i.e., “White 7-Replay-Bell”, is displayed on the center line 8c. On the periphery of the left reel 3L, Cherry symbol is arranged at the one symbol position below White 7 symbol. Accordingly, White 7 symbol on the left reel 3L is displayed in the center part of the left display window 4L, so that Cherry symbol is displayed in the lower part of the left display window 4L. Therefore, it is possible to show the player as if a medal were paid out as Cherry symbol is displayed in the lower part of the left display window 4L constituting the non-activated line.

FIG. 16C shows a display example where a combination of symbols relating to Bell 1, i.e., “Bell-Bell-Bell”, is displayed on the center line 8c. In other words, it is shown that three Bell symbols are displayed on the center line 8c in order.

FIG. 16D shows a display example where a combination of symbols relating to Bell 2, i.e., “Replay-Bell-Replay”, is displayed on the center line 8c. On the periphery of the left reel 3L, Bell symbol is arranged at the one symbol position above Replay symbol. On the periphery of the right reel 3R, Bell symbol is arranged at the one symbol position below Replay symbol. Accordingly, Replay symbol on the left reel 3L, Bell symbol on the center reel 3C and Replay symbol on the right reel 3R are respectively displayed in the center parts of the display windows 4L, 4C, 4R, so that a combination of symbols in which three Bell symbols are arranged is displayed on the cross-down line 8e. Therefore, it is possible to show the player as if a medal were paid out as three Bell symbols are arranged on the cross-down line 8e which is a non-activated line.

FIG. 16E shows a display example where a combination of symbols relating to Replay 1, i.e., “Replay-Repaly-Replay”, is displayed on the center line 8c. In other words, it is shown that three Replay symbols are displayed on the center line 8c in order.

FIG. 16F shows a display example where a combination of symbols relating to Replay 2, i.e., “Bell-Replay-Bell”, is displayed on the center line 8c. On the periphery of the left reel 3L, Replay symbol is arranged at the one symbol position below Bell symbol. On the periphery of the right reel 3R, Replay symbol is arranged at the one symbol position above Bell symbol. Accordingly, Bell symbol on the left reel 3L, Replay symbol on the center reel 3C and Bell symbol on the right reel 3R are respectively displayed in the center parts of the display windows 4L, 4C, 4R, so that a combination of symbols in which three Replay symbols are arranged is displayed on the cross-up line 8a. Therefore, it is possible to show the player as if a replay-of-game were won as three Replay symbols are arranged on the cross-up line 8a which is a non-activated line.

FIG. 16G shows a display example where a combination of symbols relating to Watermelon, i.e., “Bell-Watermelon-Cherry”., is displayed on the center line 8c. On the periphery of the left reel 3L, Watermelon symbol is arranged at the one symbol position above Bell symbol. On the periphery of the right reel 3R, Watermelon symbol is arranged at the one symbol position below Cherry symbol. Accordingly, Bell symbol on the left reel 3L, Watermelon symbol on the center reel 3C and Bell symbol on the right reel 3R are respectively displayed in the center parts of the display windows 4L, 4C, 4R, so that a combination of symbols in which three Watermelon symbols are arranged is displayed on the cross-down line 8e. Therefore, it is possible to show the player as if a medal were paid out as three Watermelon symbols are arranged on the cross-down line 8e which is a non-activated line.

As described above, in the gaming machine 1 of the embodiment, when a combination of symbols relating a winning is displayed on the center line 8c, a combination of specific symbols in accordance with the combination of symbols relating to the winning is displayed on a line different from the center line 8c.

When a combination of symbols relating to the losing is displayed on the center line 8c, a combination of symbols, in which the same type of three symbols, for example “Bell-Bell-Bell” or “Watermelon-Watermelon-Watermelon” are arranged, is not displayed on a line other than the center line 8c. Accordingly, the player is prevented from misunderstanding that a winning is achieved.

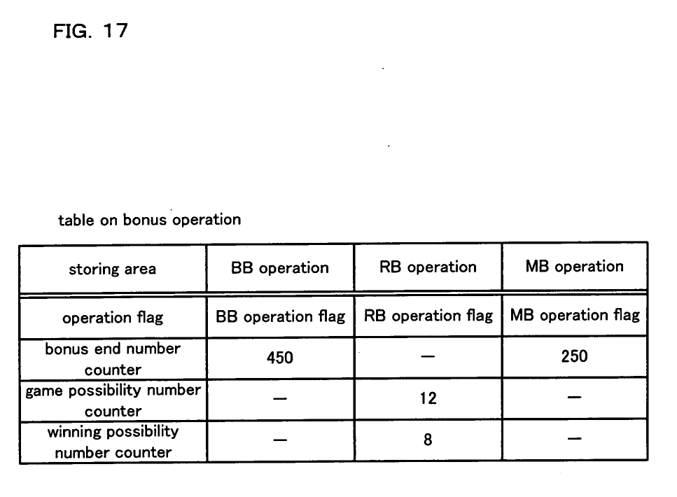

In the followings, a table on bonus operation is described with reference to FIG. 17.

The table on bonus operation defines data stored in a predetermined area of the RAM 33. When BB starts to operate, the BB operation flag of the RAM 33 is set to ON, and 450 is stored in a bonus end number counter. The bonus end number counter stores the total number of payouts under the BB or MB operation, and a payout number determined is subtracted every unit game from the value of the bonus end number counter. When the value of the bonus end number counter becomes 0, the BB operation is over.

When RB starts to operate, a RB operation flag of the RAM 33 is set to ON, 12 is stored in a game possibility number counter, and 8 is stored in a winning possibility number counter. The game possibility number counter stores the number of unit games which can be carried out under RB operation, and 1 is subtracted whenever a unit game is carried out from the value of the game possibility number counter. The winning possibility number counter stores the number of times that the winning can be achieved under RB operation, and 1 is subtracted whenever a winning is achieved from the value of the winning possibility number counter. When the value of the game possibility number counter or of the winning possibility number counter becomes 0, the RB operation is over.

When MB starts to operate, the MB operation flag of the RAM 33 is set to ON, 250 is stored in the bonus end number counter. When the value of the bonus end number counter becomes 0, the MB operation is over.

In the followings, it is described an internal winning combination storing area of the RAM 33 of the main control circuit 71, with reference to FIG. 18.

An internal winning combination determined by the internal winning combination determining table is memorized in the internal winning combination storing area. The data stored in the internal winning combination storing area consists of 3 bytes and corresponds to the data of the internal winning combination described above. In other words, the bit corresponding to the type of the determined internal winning combination is ON. In the data of the losing, all bits are 0. When two or more types of internal winning combinations are determined, the bits corresponding to each type are ON. For example, when BB1 and Cherry 1 are determined, the bits 13 and 2 of the internal winning combination storing area are ON. A display combination determined on the basis of the symbol combination table is stored in the display combination storing area of the RAM 33. The display combination storing area has the same structure as the internal winning combination storing area.

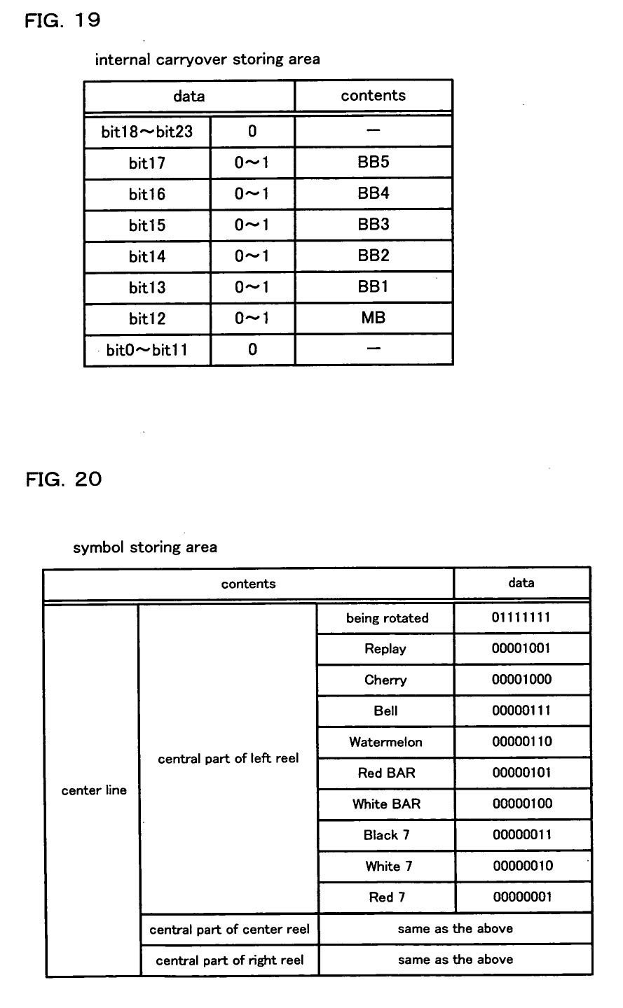

In the followings, it is described an internal carryover combination storing area of the RAM 33 of the main control circuit 71, with reference to FIG. 19.

Data relating to MB, BB1, BB2, BB3, BB4 or BB5 which is determined as the internal winning combination by the internal winning combination determining table is stored in the internal carryover winning combination storing area. The internal carryover winning combination consists of 3 bytes. MB1, BB1, BB2, BB3, BB4 and BB5 correspond to the bits 12 to 17, respectively. When the MB or BB operation starts, the internal carryover combination storing area is cleared. In other words, in the gaming machine 1, when a bonus is determined as an internal winning combination, the data thereof is kept stored until the combination of symbols corresponding the bonus is displayed on the activated line and the MB operation starts. The internal carryover combination, which is determined on the basis of the internal winning combination, can be said to be a subordinate concept of the internal winning combination.

Next, it is described a symbol storing area of the RAM 33 of the main control circuit 71 with reference to FIG. 20.

The data representing symbols displayed in the central parts of the respective display windows 4L, 4C, 4R, i.e., displayed on the center line 8c, is stored in the symbol storing area. Specifically, a symbol located in the central part of the left display window 4L, a symbol located in the central part of the center display window 4C and a symbol located in the right part of the left display window 4R are respectively recorded. The data of respective symbols stored in the symbol storing area is specified on the basis of the value of the symbol position counter and the symbol arrangement table. For example, if the value of the symbol position counter of the stopped reel is “0”, a symbol of the symbol position “0” is specified on the basis of the symbol arrangement table and the symbol data is stored in the symbol storing area. In the gaming machine 1, it is determined whether a combination of symbols relating to a winning has been displayed on the basis of the data stored in the symbol storing area and the symbol combination table.

The data stored for each center parts of the display windows 4L, 4C, 4R in the symbol storing area consists of one byte and corresponds to the data representing the symbol defined in the symbol arrangement table described above. The data representing that the reel is being rotated may be stored in the symbol storing area, which is expressed by “01111111”.

The symbol storing area may store not only the data representing the symbols displayed on the center line 8c but also data representing symbols respectively displayed on the top line 8b, the bottom line 8d, the cross-up line 8a, and the cross-down line 83.

Hereinafter, a control carried out by the CPU 31 of the main control circuit 71 is described with reference to flow charts shown in FIGS. 21 to 31.

First, a reset-intervention process is described with reference to FIG. 21, which is executed by the CPU 31 of the main control circuit 71. When power is inputted and a voltage is applied to a reset terminal, the CPU 31 generates a reset-intervention and sequentially carries out a reset-intervention process which is stored in the ROM 32, on the basis of the generation of the reset-intervention.

When the power is inputted, the CPU first executes an initialization process (step S1). In the initialization process, carried out is a process of restoring an execution address or data of a register stored in the RAM 33 when the power is cut off.

Next, the CPU 31 clears an indicated storing area (step S2). Thereby, the data stored in the internal winning combination storing area, etc. of the RAM 33 is cleared.

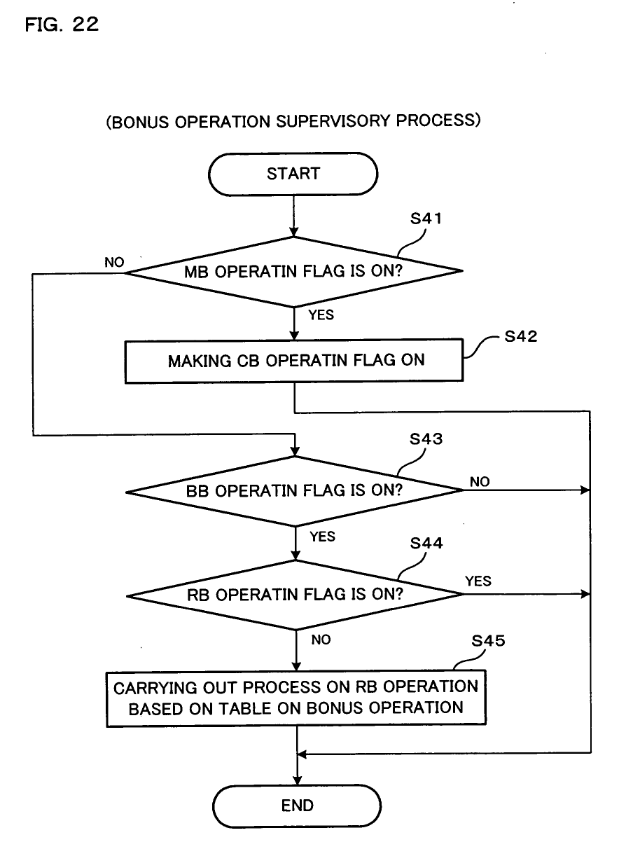

Next, the CPU 31 executes a bonus operation supervisory process which will be described with reference to FIG. 22 (step S3). In the bonus operation supervisory process, a RB or CB operation is carried out.

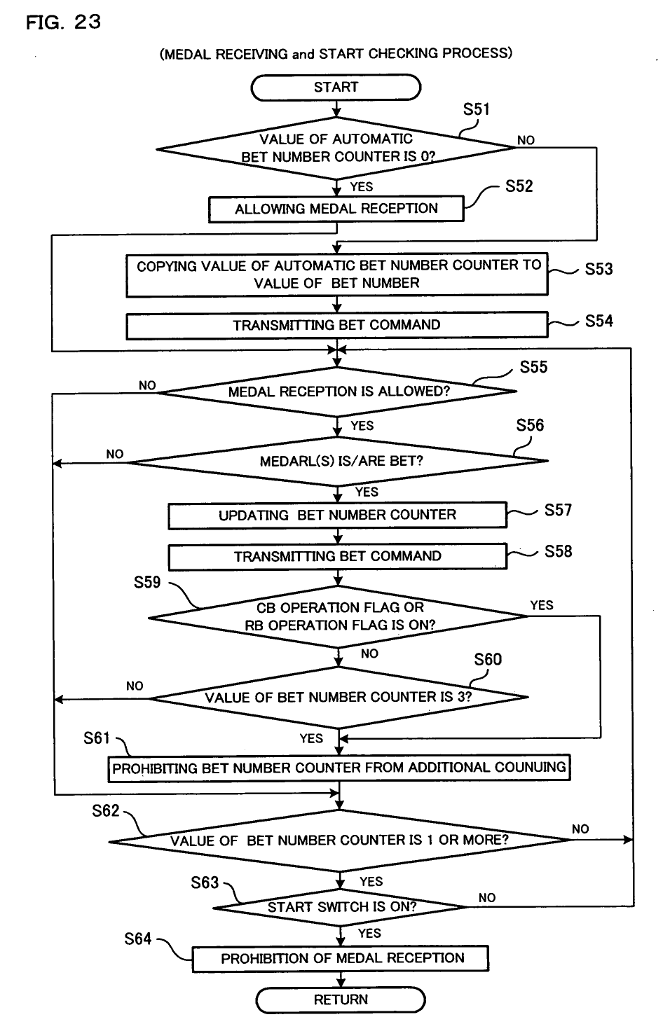

Next, the CPU 31 executes a medal receiving and start checking process which will be described later with reference to FIG. 23 (step S4). In the medal receiving and start checking process, a BET number counter is updated through the check of the medal sensor 22S, the BET switches 11S, 12S, 13S and the like, and the input of the start switch 6S is checked.

Next, the CPU 31 samples and stores a random number in the random number storing area (step S5). Specifically, the CPU 31 samples a random number for lottery by the random number generator 36 and the sampling circuit 37, which is used in the internal lottery process and the like, and stores it in the random number storing area of the RAM 33.

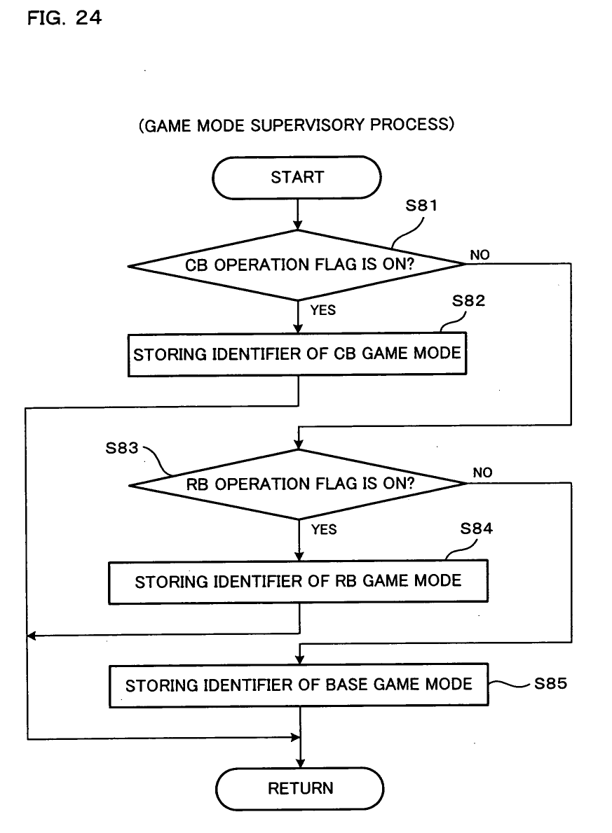

Next, the CPU 31 executes a game mode supervisory process (step S6) which will be described with reference to FIG. 24. In the game mode supervisory process, determined is a RB game mode, a CB game mode or a normal game mode.

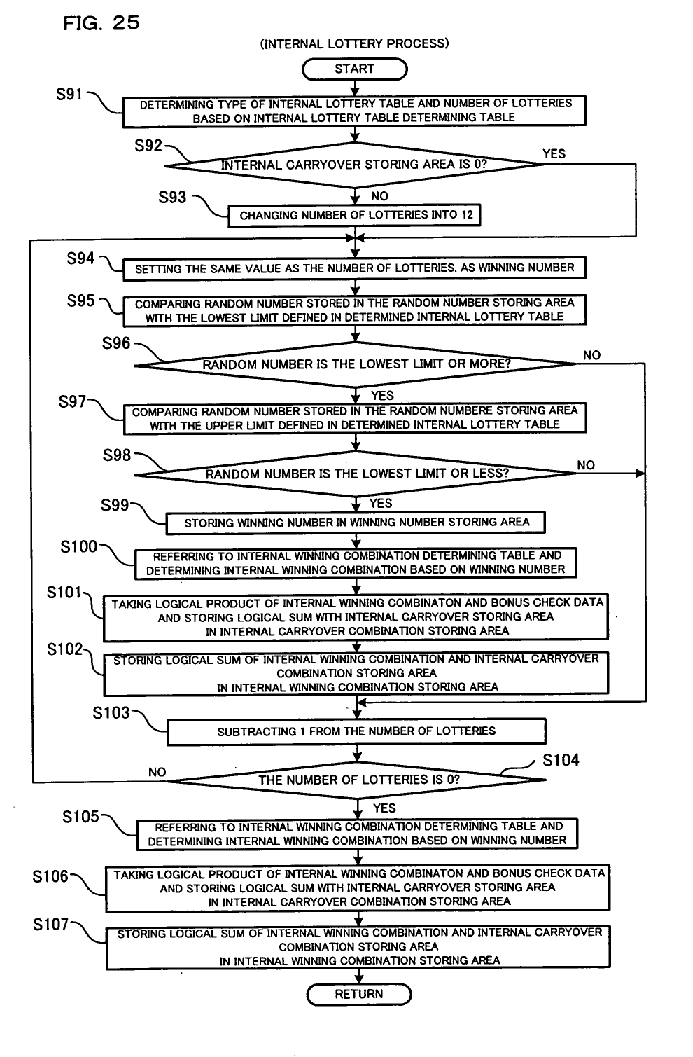

Next, the CPU 31 performs an internal lottery process which will be described later with reference to FIG. 25 (step S7). In the internal lottery process, a process of determining an internal winning combination and the like is carried out.

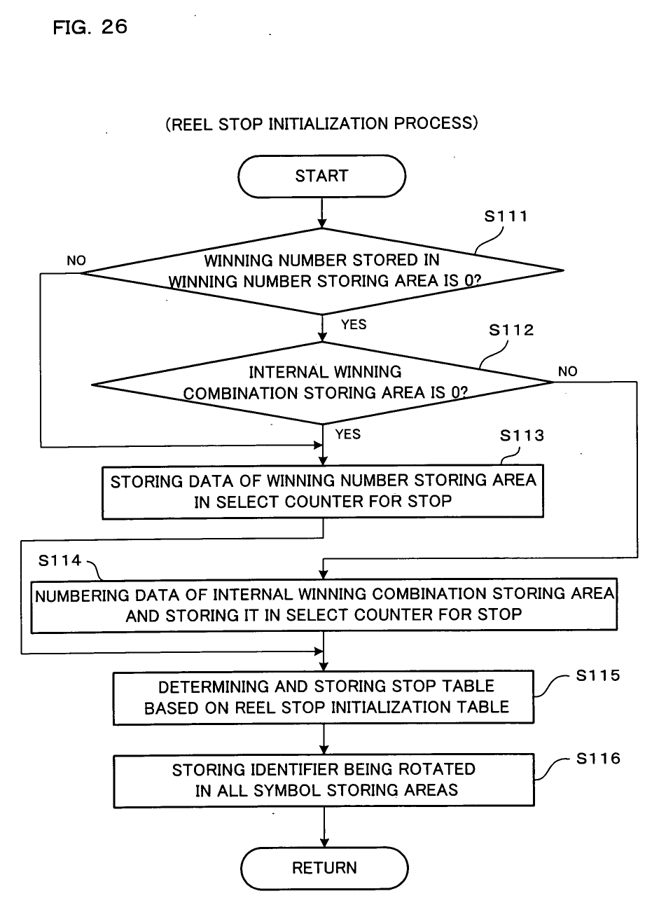

Next, the CPU 31 carries out a reel stop initialization process which will be described later with reference to FIG. 26 (step S8). In the reel stop initialization process, a process of determining a stop table is carried out based on the winning number and the reel stop initialization table.

Next, the CPU 31 transmits a start command to the sub-control circuit 72 (step S9). The start command contains data such as internal winning combination, game mode and the like.

Next, the CPU 31 determines whether 4.1 seconds have lapsed after a previous start-of-rotation of reels (step S10). When it is determined that 4.1 seconds have not lapsed, the CPU 31 consumes the time (step S11). Specifically, a subsequent process is not carried out until 4.1 seconds have lapsed.

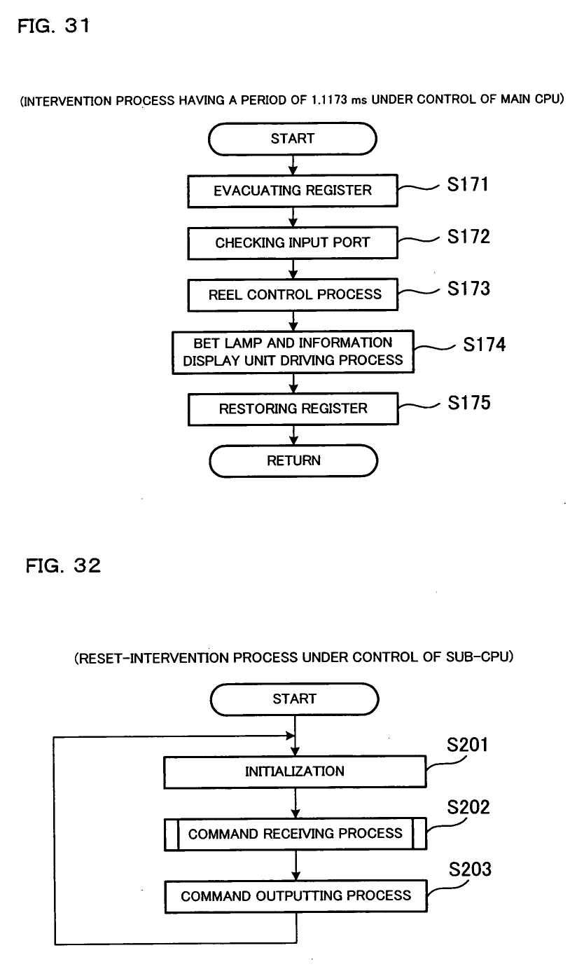

When it is determined that 4.1 seconds have lapsed, or after the process in the step S11, the CPU requests rotation start of all the reels (step S12). When requested, a process of starting to rotate the reels is carried out in an intervention process (see FIG. 31) which will be described later.

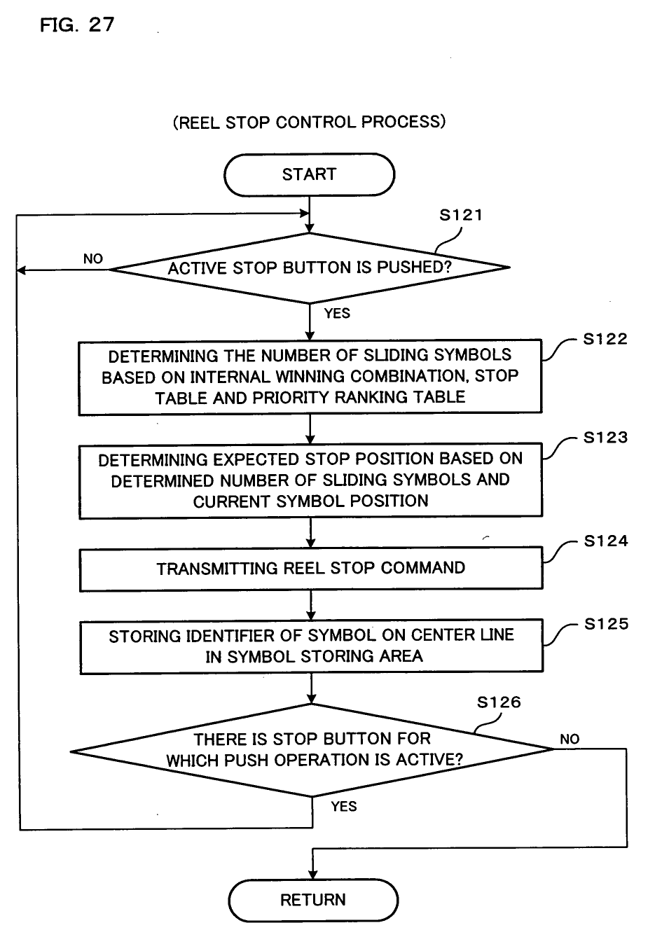

Next, the CPU 31 executes a reel stop control process which will be described later with reference to FIG. 27 (step S13). In the reel stop control process, the number of sliding symbols and an expected stop position are determined on the basis of the stop table, and a process of stopping the rotation of the reel is carried out based on the corresponding expected stop position.

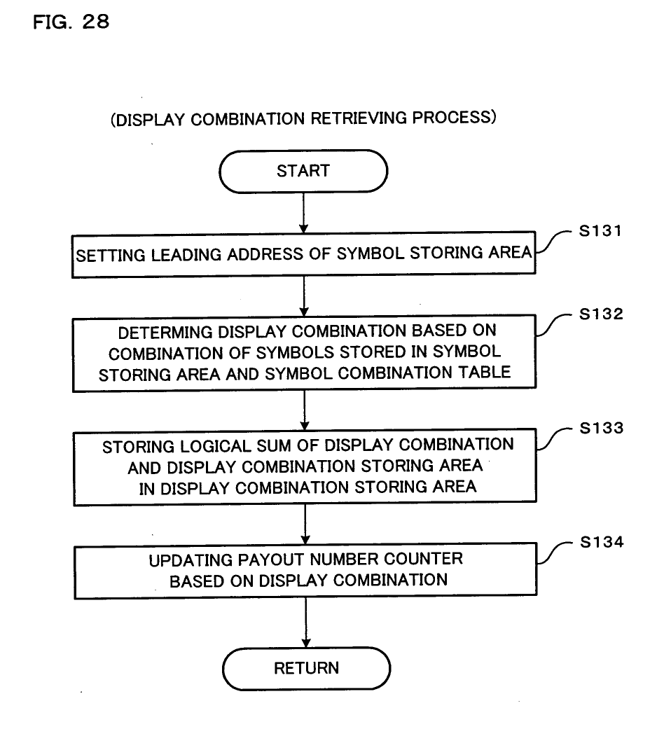

Next, the CPU 31 carries out a display combination retrieving process which will be described later with reference to FIG. 28 (step S14). In this display combination retrieving process, determination of a display combination and a payout number is performed based on the symbol storing area and the symbol combination table.

Next, the CPU 31 transmits a display combination command to the sub-control circuit 72 (step S15). The display combination command includes data such as a display combination determined and the like.

Next, the CPU 31 carries out a medal payout process (step S16). Specifically, the CPU 31 controls the hopper 40 or updates a credit counter, based on the payout number determined in the step S14. The credit counter counts the number of medals credited.

Next, the CPU 31 updates a bonus end number counter based on the payout number (step S17). Specifically, when the value of the bonus end number counter is 1 or more, the CPU 31 subtracts a value corresponding to the payout number from the value of the corresponding counter.

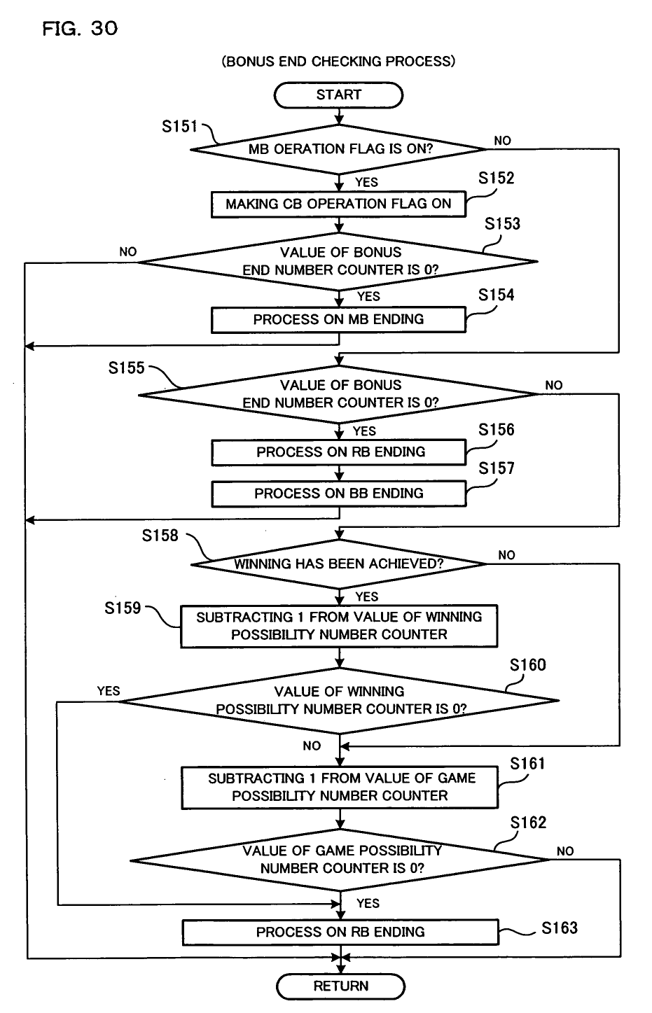

Next, the CPU 31 determines whether one of the BB operation flag and the MB operation flag is ON (step S18). If it is determined that one of the BB operation flag or the MB operation flag is ON, the CPU 31 carries out a bonus end checking process which will be described later with reference to FIG. 30 (step S19). In the bonus end checking process, a process relating to the ending of the BB operation or MB operation is carried out based on the update result of the bonus end number counter.

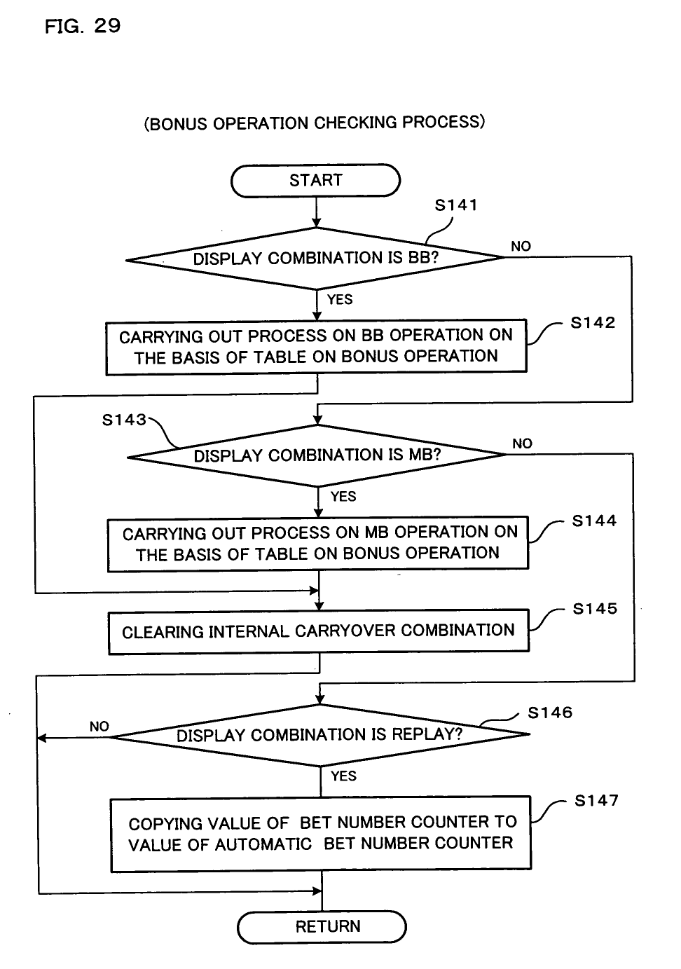

When it is determined that both the BB operation flag and the MB operation flag are not ON in the step of S18, or after the process in the step S19, the CPU 31 carries out a bonus operation checking process which will be described with reference to FIG. 29 (step S20). In the bonus operation checking process, when a display combination is BB or MB, a process of starting an operation of a bonus is carried out.

Like this, the CPU 31 executes the steps S2 to S20 as processes in a unit game. When the step S20 is over, the CPU returns the process to the step S2 so as to carry out the processes in a next unit game.

In the followings, a bonus operation supervisory process is described with reference to FIG. 22.

First, the CPU 31 determines whether the MB operation flag is ON or not (step S41). When it is determined that the MB operation flag is ON, the CPU 31 makes a CB operation flag ON (step S42). When this process is over, the CPU ends the bonus operation supervisory process and proceeds to a step S4. Like this, in the gaming machine 1, if the MB operation flag is ON, the operation of CB is carried out every unit game. In addition, during the MB operation, the operation of CB is continuously carried out.

When it is determined that the BB operation flag is not ON, the CPU 31 determines whether the BB operation flag is ON or not (step S43). When it is determined that the BB operation flag is not ON, the CPU 31 ends the bonus operation supervisory process and proceeds to the step S4 in FIG. 21.

When it determined that the BB operation flag is ON in the step S43, the CPU 31 determines whether the RB operation flag is ON or not (step S44). If it is determined that the RB operation flag is ON, the CPU 31 ends the bonus operation supervisory process and proceeds to the step S4 in FIG. 21.

When it is determined that the RB operation flag is not ON in the step S44, the CPU 31 carries out a process on RB operation on the basis of a table on bonus operation (step S45). Specifically, the CPU 31 makes the RB operation flag ON, stores 12 in the game possibility number counter and stores 8 in the winning possibility number counter. Like this, in the gaming machine 1, if the BB operation flag is ON, even though the operation of RB is over, the operation of RB is immediately started in a next unit game and continuously carried out during the BB operation. When this process is over, the CPU ends the bonus operation supervisory process and proceeds to the step S4 in FIG. 21.

In the followings, a medal receiving and start checking process is described with reference to FIG. 23.

First, the CPU 31 determines whether the value of an automatic BET number counter is 0 or not (step S51). When it is determined that the value of medal (step S52). The automatic BET number counter is used for discriminating whether Replay has been achieved in the previous unit game. If Replay has been achieved in the previous unit game, the automatic BET number counter stores the BET number in that unit game.

When it is determined that the value of the automatic BET number counter is not 0 in the step S51, the CPU 31 copies the value of the automatic bet number counter to the value of a BET number counter (step S53). The BET number counter stores data of the BET number for a unit game.

Next, the CPU 31 transmits a BET command to the sub-control circuit 72 (step S54). The BET command includes data of the BET number and the like.

After the process in the step S54 or the process in the step S52, the CPU 51 determines whether the reception of medal has been allowed or not (step S55). When it is determined that the reception of medal has been allowed, the CPU 31 determines whether or not the medal(s) is/are bet based on a detected signal from the medal sensor 22S, the BET switch 11S, 12S, or 13S or the like (step S56).

When it is determined that the medal(s) is/are bet in the step S56, the CPU 31 calculates a value to be stored in the BET number counter based on the detected signal from the medal sensor 22S, the BET switch 11S, 12S, or 13S or the like, and updates the BET number counter (step S57). Here, when four or more medals are inserted and when the BET number counter is prohibited from additional counting as described later, the CPU 31 updates the credit counter, instead of the BET number counter.

Next, the CPU 31 transmits the BET command to the sub-control circuit 72 (step S58). Then, the CPU 31 determines whether one of the CB operation flag and the RB operation flag is ON or not (step S59). When it is determined that both the CB operation flag and RB operation flag are not ON, the CPU 31 determines whether the value of the BET number counter is 3 or not (step S60).

When it is determined that the value of the BET number counter is 3, or when it is determined that one of the CB operation flag and the RB operation flag is ON in the step S59, the CPU prohibits the BET number counter from additional counting (step S61).

After the process in the step S61, when it is determined that the reception of medal has not been allowed in step S55, when it is determined that no medal is bet in the step S56, or when it is determined that the value of the BET number counter is not 3 in the step S60, the CPU 31 determines whether the value of the BET number counter is 1 or more (step S62). If it is determined that the value of the BET number counter is not 1 or more, the CPU 31 returns the process to the step S55.

When it is determined that the value of the BET number counter is 1 or more in the step S62, the CPU 31 determines whether the start switch 6S is ON or not (step S63). When it is determined that the start switch 6S is not ON, the CPU 31 returns the process to the step S55.

When it is determined that the start switch 6S is ON, the CPU 31 prohibits the reception of medal (step S64). When this process is over, the CPU ends the medal receiving and start checking process and proceeds to the step S5 in FIG. 21.

In the followings, a game mode supervisory process is described with reference to FIG. 24.

First, the CPU 31 determines whether the CB operation flag is ON or not (step S81). When it is determined that the CB operation flag is ON, the CPU 31 stores an identifier of the CB game mode in a predetermined area of the RAM 33 (step S82). When this process is over, the CPU ends the game mode supervisory process and proceeds to the step S7 in FIG. 21.

When it is determined that the CB operation flag is not ON in the step S81, the CPU 31 determines whether the RB operation flag is ON or not (step S83). If it is determined that the RB operation flag is ON, the CPU 31 stores an identifier of the RB game mode in a predetermined area of the RAM 33 (step S84). When this process is over, the CPU ends the game mode supervisory process and proceeds to the step S7 in FIG. 21.

When it is determined that the RB operation flag is not ON in the step S83, the CPU 31 stores an identifier of the base game mode in a predetermined area of the RAM 33 (step S85). When this process is over, the CPU ends the game mode supervisory process and proceeds to the step S7 in FIG. 21.

In the followings, an internal lottery process is described with reference to FIG. 25.

First, the CPU 31 determines a type of the internal lottery table and the number of lotteries, based on the game mode and the internal lottery table determining table (step S91).

Next, the CPU 31 determines whether the data in the internal carryover combination storing area is 0 or not, i.e., whether there is an internal carryover combination (step S92). When it is determined that the data in the internal carryover combination storing area is not 0, the CPU 31 changes the number of lotteries into 12 (step S93). Thereby, when there is an internal carry over combination in the base game mode, the number of lotteries determined to be 18 times is changed to 12 times and a bonus is thus not determined duplicately.

When it is determined that the data in the internal carryover combination storing area is 0 in the step S92, or after the process in the step S93, the CPU 31 sets a value same as the number of lotteries, as a winning number (step S94).

Next, the CPU 31 compares the random number stored in the random number storing area with the lowest limit defined in the internal lottery table (step S95). Then, the CPU 31 determines whether the random number is the lowest limit or more (step S96).

When it is determined that the random number is the lowest limit or more, the CPU 31 compares the random number stored in the random number storing area with the upper limit defined in the internal lottery table (step S97). Then, the CPU 31 determines whether the random number is the upper limit or less (step S98).

When it is determined that the random number is the upper limit or less, the CPU 31 stores the set winning number in a winning number storing area of the RAM 33. The winning number storing area has an initial value of 0 and is sequentially overwritten as this process is carried out.

Next, the CPU 31 refers to the internal winning combination determining table to determine an internal winning combination based on the winning number stored in the winning number storing area (step S100). Then, the CPU 31 takes a logical product of the determined internal winning combination and bonus check data and stores a logical sum with the internal carryover combination storing area in the internal carryover combination storing area (step S101). The bonus check data is expressed by 3 bytes of data, in which the bits 12 to 17 are all ON. As a result of this process, when the internal winning combination is a bonus, a carryover is carried out. Next, the CPU 31 stores a logical sum of the internal winning combination and the internal carryover combination storing area in the internal winning combination storing area (step S 102).

After the process in the step S102, when it is determined that the random number is not the lowest limit or more in the step S96, or when it is determined that the random number is not the upper limit or less, the CPU 31 subtracts 1 from the number of lotteries (step S103).

Next, the CPU 31 determines whether the number of lotteries is 0 or not (step S104). When it is determined that the number of lotteries is not 0, the CPU 31 returns the process to the step S94.

When it is determined that the number of lotteries is 0 in the step S104, the CPU 31 refers to the internal winning combination determining table and determines an internal winning combination based on the winning number (step S105). In this process, when the initial value 0 is stored in the winning number storing area, the losing is determined.

Next, the CPU takes a logical product of the determined internal winning combination and the bonus check data, and stores a logical sum with the internal carryover combination storing area in the internal carryover combination storing area (step S106). Then, the CPU 31 stores a logical sum of the internal winning combination and the internal carryover combination storing area in the internal winning combination storing area of the RAM 33 (step S107). When this process is over, the CPU ends the internal lottery process and proceeds to the step S8 in FIG. 21.

In the followings, a reel stop initialization process is described with reference to FIG. 26.

First, the CPU 31 determines whether the winning number stored in the winning number storing area is 0, i.e., the losing, or not (step S111). When it is determined that the winning number is 0, the CPU 31 determines whether the data in the internal winning combination storing area is 0 or not, i.e., whether there is the internal carryover combination or not (step S112).

When it is determined that the winning number is not 0 in the step S111, or when it is determined that the data in the internal winning combination storing area is 0 in the step S112, the CPU 31 stores the data of the winning number storing area in a select counter for stop (step S113).

When it is determined that the internal winning combination storing area is not 0 in the step S112, the CPU 31 numbers the data of the internal winning combination storing area and stores it in the select counter for stop (step S114). For example, when the data of the internal winning combination storing area is MB (i.e., the bit 12 is ON), the CPU stores 13. When the data of the internal winning combination storing area is BB5 (i.e., the bit 17 is ON), the CPU stores 18.

After the process in the step S113 or step S114, the CPU 31 determines and stores a stop table based on the select counter for stop and the reel stop initialization table in the RAM 33 (step S115).

Next, the CPU 31 stores the identifier being rotated in the symbol storing area (step S116). When this process is over, the CPU ends the reel stop initialization process and proceeds to the step S9 in FIG. 21.

In the followings, a reel stop control process is described with reference to FIG. 27.

First, the CPU 31 determines whether an active stop button has been pushed or not (step S121). When it is determined that the active stop button has not been pushed, the CPU 31 repeats the process in the step S121. In order to carry out a so-called automatic stop, the CPU 31 may determine whether the active stop button has been pushed and also determine whether a predetermined time, for example, 30 sec, has lapsed after the start switch 6S has been ON.

When it is determined that the active stop button has been pushed in the step S121, the CPU 31 annuls the push operation of the corresponding stop button and determines the number of sliding symbols on the basis of the internal winning combination, the stop table and the priority ranking table (step S1 22).

In this embodiment, the number of sliding symbols is basically determined on the basis of the stop table. At this time, when there is a symbol position capable of attracting-in a symbol relating to an internal winning combination, specifically, a symbol relating to data stored in the internal winning combination storing area, within a range of 4 symbols from the stop starting position, a difference up to the corresponding symbol position is determined as the number of sliding symbols. For example, when BB1 is carried over, if the winning number 3, i.e., Bell 1, has been determined, the stop table for Bell 1 is determined. At this time, if there is a symbol position capable of attracting-in Red 7 symbol relating to BB1 having the higher priority ranking within a range of 4 symbols from the stop starting position, a difference up to the corresponding symbol position is determined as the number of sliding symbols.

Next, the CPU 31 determines an expected stop position based on the number of sliding symbols determined and the current symbol position (step S123). For example, when the number of sliding symbols determined is “2” and the current symbol position, i.e., stop starting position, is “19”, an expected stop position is determined as “0”. When the expected stop position is stored, it is carried out a process of stopping the rotation of the reel based on the expected stop position in an intervention process (see FIG. 31) which will be described later. The number of sliding symbols and the expected stop position, one of which is determined when the other is determined, are equivalent to each other.

Next, the CPU 31 transmits a reel stop command to the sub-control circuit 72 (step S124). The reel stop command includes data of the type of the stopped reel, and the like.

Next, the CPU 31 stores an identifier of a symbol on the center line 8c which is the activated line in the symbol storing area (step S125). For example, if the value of the symbol position counter of the stopped reel is “0”, the symbol arrangement table is referred to and the type of the symbol located at the symbol position “0” is stored in the symbol storing area.

Next, the CPU 31 determines whether there is the stop button for which the push operation is active, i.e., whether there is a reel being rotated (step S126). When it is determined that there is the stop button for which the push operation is active, the CPU 31 returns the process to the step S121. When it is determined that there is no stop button for which the push operation is active, the CPU 31 ends the reel stop control process and proceeds to the step S14 in FIG. 14.

In the followings, a display combination retrieving process is described with reference to FIG. 28.

First, the CPU 31 sets a leading address of the symbol storing area (step S131). Then, the CPU 31 determines a display combination based on the combination of symbols stored in the symbol storing area and the symbol combination table (step S132). Specifically, the CPU 31 determines whether the combination of symbols displayed on the center line 8c, data of which is stored in the symbol storing area, is identical to any of the combinations of symbols defined in the symbol combination table, and determines a display combination.

Next, the CPU 31 stores a logical sum of the display combination and the display combination storing area in the display combination storing area (step S133). Then, the CPU 31 refers to the symbol combination table, determines the payout number based on the determined display combination and updates the payout number counter (step S134). When this process is over, the CPU ends the display combination retrieving process and proceeds to the step S15 in FIG. 21.

In the followings, a bonus operation checking process is described with reference to FIG. 29.

First, the CPU 31 determines whether the display combination is one of BB1, BB2, BB3, BB4 and BB5 (step S141). When it is determined that the display combination is one of BB1, BB2, BB3, BB4 and BB5, the CPU 31 carries out the process on BB operation based on the table on bonus operation (step S142).

When it is determined that the display combination is not any one of BB1, BB2, BB3, BB4 and BB5 in the step S141, the CPU 31 determines whether the display combination is MB or not (step S143). When it is determined that the display combination is MB, the CPU 31 carries out the process on MB operation based on the table on bonus operation (step S144).

After the process in the step S144, or after the process in the step S142, the CPU 31 clears the internal carryover combination storing area (step S145). When this process is over, the CPU ends the bonus operation checking process and proceeds to the step S2 in FIG. 21.

When it is determined that the display combination is not MB in the step S143, the CPU 31 determines whether the display combination is Replay or not (step S146). When it is determined that the display combination is not Replay, the CPU ends the bonus operation checking process and proceeds to the step S2 in FIG. 21.

When it is determined that the display combination is Replay in the step S146, the CPU 31 copies the value of the BET number counter to the value of the automatic BET counter (step S147). When this process is over, the CPU ends the bonus operation checking process and proceeds to the step S2 in FIG. 21.

In the followings, a bonus end checking process is described with reference to FIG. 30.

First, the CPU 31 determines whether the MB operation flag is ON or not (step S151). When it is determined that the MB operation flag is ON, the CPU 31 makes the CB operation flag OFF (step S152).

Next, the CPU 31 determines whether the value of the bonus end number counter is 0 or not (step S153). When it is determined that the value of the bonus end number counter is not 0, the CPU ends the bonus end checking process and proceeds to the step S20 in FIG. 21.

When it is determined that the value of the bonus end number counter is 0 in the step S153, the CPU 31 carries out a process on MB ending (step S154). Specifically, the CPU makes the MB operation flag OFF, and clears the bonus end number counter. When this process is over, the CPU ends the bonus end checking process and proceeds to the step S20 in FIG. 21.

When it is determined that the MB operation flag is not ON, i.e., when it is determined that the BB operation flag is ON, the CPU 31 determines whether the value of the bonus end number counter is 0 or not (step S155).

When it is determined that the value of the bonus end number counter is 0 in the step S155, the CPU carries out a process on RB ending (step S156). Specifically, the CPU makes the RB operation flag OFF, and clears the winning possibility number counter and the game possibility number counter. Then, the CPU 31 carries out a process on BB ending (step S157). Specifically, the CPU 31 makes the BB operation flag OFF, and clears the bonus end number counter. When this process is over, the CPU ends the bonus end checking process and proceeds to the step S20 in FIG. 21.

When it is determined that the value of the bonus end number counter is not 0 in the step S155, the CPU 31 determines whether a winning has been achieved or not (step S158). When it is determined that a winning has been achieved, the CPU 31 subtracts 1 from the value of the winning possibility number counter (step S159). Then, the CPU 31 determines whether the value of the winning possibility number counter is 0 or not (step S160).

When it is determined that the value of the winning possibility number counter is not 0 in the step S160, or when it is determined that a winning has not been achieved in the step S158, the CPU 31 subtracts 1 from the value of the game possibility number counter (step S161). Then, the CPU 31 determines whether the value of the game possibility number counter is 0 or not (step S162).

When it is determined that the value of the game possibility number counter is not 0 in the step S162, the CPU 31 ends the bonus end checking process and proceeds to the step S20 in FIG. 21.

When it is determined that the value of the game possibility number counter is 0 in the step S162, or when the value of the winning possibility number counter is 0 in the step S160, the CPU 31 carries out the process on RB ending (step S163), likewise in the process in the step S156. When this process is over, the CPU ends the bonus end checking process and proceeds to the step S20 in FIG. 21.

In the followings, it is described an intervention process having a period of 1.1173 ms which is carried out under control of the CPU 31 of the main control circuit 71, with reference to FIG. 31.

First, the CPU 31 evacuates a register (step S171). Next, the CPU 31 checks an input port (step S172). Specifically, the CPU 31 checks an input of a signal from each switch and the like.

Next, the CPU 31 carries out a reel control process (step S173). Specifically, when it has been made the request for the rotation start of the reel, the CPU 31 starts to rotate the reels 3L, 3C, 3R and carries out the rotations at a constant speed. In addition, when the expected stop position has been determined, the CPU waits until the symbol position counter of the corresponding reel is updated to the same value as the expected stop position, and then slows down and stops the rotation of the corresponding reel. For example, if the value of the symbol position counter is “19” and the value of the expected stop position is “0”, the CPU stops the rotation of the reel when symbol position counter becomes “0”.

Next, the CPU 31 performs a BET lamp and information display unit driving process (step S174). Specifically, the CPU 31 turns on one of the BET lamps 9a, 9b, 9c on the basis of the BET number counter and displays the payout number when the winning is achieved on the information display unit 18, etc.

Next, the CPU 31 carries out a restore of the register (step S175). When this process is over, the CPU ends the intervention process having a period of 1.1173 ms.

Hereinafter, a control operation of the sub-control circuit 72 is described with reference to flow charts shown in FIGS. 32 to 34.

First, a reset-intervention process is described with reference to FIG. 32, which is executed in the sub-control circuit 72. When power is inputted and a voltage is applied to a reset terminal, the image control MICOM 81 of the sub-control circuit 72 generates a reset-intervention and sequentially carries out a reset-intervention process which is stored in the ROM 32, on the basis of the generation of the reset-intervention.

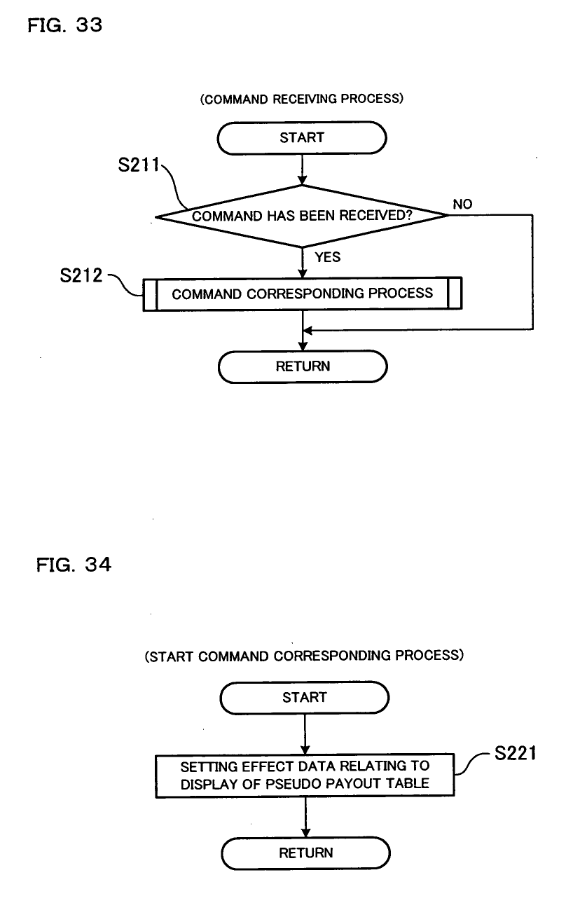

First, the image control MICOM 81 initializes the register, the work RAM 84 and the like (step S201). Then, the image control MICOM 81 carries out a command receiving process which will be described with reference to FIG. 33 (step S202). In the command receiving process, data of effect, which is performed by the liquid crystal display device 5, the LED 101, the lamp 102, the speakers 21L, 21R and the like, is determined in accordance with the type of the received command.

Next, the image control MICOM 81 carries out a command outputting process (step S203). In the command outputting process, the image control MICOM 81 controls the driving of the liquid crystal display device 5, the LED 101, the lamp 102 or the speakers 21L, 21R, based on the effect data determined, to perform an effect by use of image, sound and light. When the command outputting process is over, the image control MICOM 81 returns the process to the step S201.

Next, a command receiving process is described with reference to FIG. 33. First, the image control MICOM 81 determines whether a command has been received from the main control circuit 71 or not (step S211). When it is determined that the command has not been received, the image control MICOM 81 ends the command receiving process and proceeds to the step S203 in FIG. 32. When it is determined that the command has been received, the image control MICOM 81 carries out a command corresponding process (step S212). In the command corresponding process, carried out is a start command corresponding process and the like which will be described with reference to FIG. 34. When this process is over, the image control MICOM proceeds to the step S203 in FIG. 32.

In the followings, it is described a start command corresponding process which is carried out in correspondence with the start command received from the main control circuit 71.

The image control MICOM 81 sets the effect data relating to the display of the pseudo payout table (step S221). When this process is over, the image control MICOM ends the start command corresponding process and proceeds to the step S203 in FIG. 32. When the effect data relating to the display of the pseudo payout table is set, the pseudo payout table is displayed on the liquid crystal display unit 5a of the liquid crystal display device 5 in the command outputting process in the step $203 of FIG. 32. In this embodiment, the pseudo payout table is displayed when the start command is received to detect the start operation by the player. However, the invention is not limited thereto. The timing and period of displaying the pseudo payout table may be arbitrarily changed.

In the followings, it is described a display example of the pseudo payout table displayed on the liquid crystal display unit 5a of the liquid crystal display device 5.

The pseudo payout table is an image representing a corresponding relationship between a prize in accordance with the combination of symbols relating to the winning and the combination of specific symbols displayed on the another line except the center line 8c when the combination of symbols relating to the winning is displayed on the center line 8c.

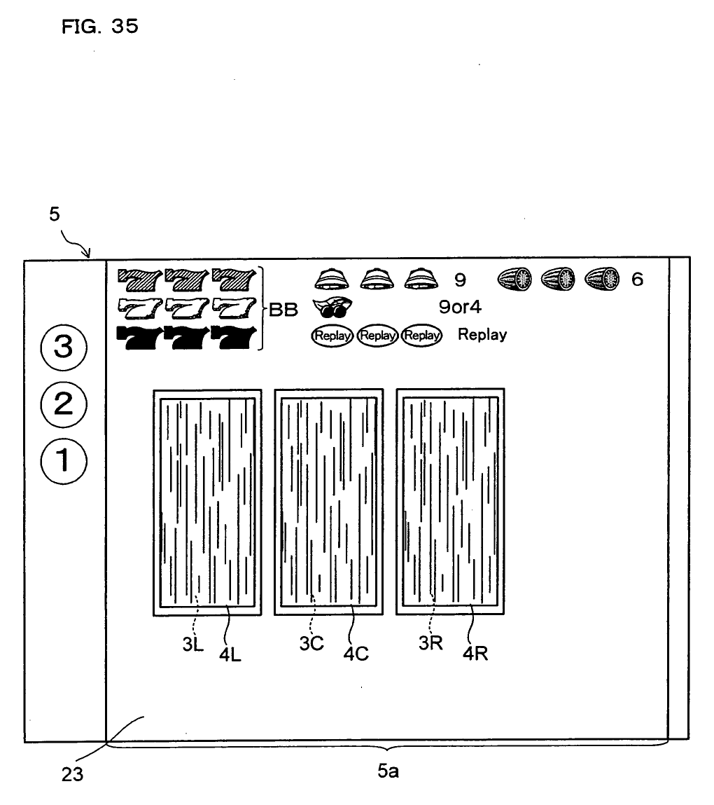

As shown in FIG. 35, the pseudo payout table is shown above the display windows 4L, 4C, 4R of the effect display area 23. In the pseudo payout table, it is shown a prize “BB” corresponding to a combination of symbols in which three Red 7 symbols are arranged, i.e., “Red 7-Red 7-Red 7”, a combination of symbols in which three White 7 symbols are arranged, i.e., “White 7-White 7-White 7”, and a combination of symbols in which three Black 7 symbols are arranged, i.e., “Black 7-Black 7-Black 7”. It is shown that a prize corresponding to a combination of symbols in which three Bell symbols are arranged, i.e., “Bell-Bell-Bell” leads the payout number “9”. It is shown that a prize corresponding to a combination of symbols in which Cherry symbol is displayed on the left display window 4L, i.e., “Cherry-ANY-ANY” leads the payout number “9” or “4”. Additionally, it is shown that a prize “Replay” corresponding to a combination of symbols in which three Replay symbols are arranged, i.e., “Replay-Replay-Replay”. Further, it is shown that a prize corresponding to a combination of symbols in which three Watermelon symbols are arranged, i.e., “Watermelon-Watermelon-Watermelon” leads the payout number 6.

The pseudo payout table is displayed as described above, so that when a combination of symbols relating to a winning, for example, a combination of symbols relating to Watermelon “Bell-Watermelon-Cherry”, is displayed on the center line 8c, the player can perceive what kind of prize will be awarded on the basis of a combination of specific symbols displayed on the another line, for example, “Watermelon-Watermelon-Watermelon”.

As described above, the gaming machine 1 of the embodiment is adapted to determine whether a winning is achieved or not, on the basis of only the combination of symbols displayed on the center line 8c of the lines 8a to 8e provided in the display windows 4L, 4C, 4R, when the rotations of all the reels 3L, 3C, 3R are stopped. Accordingly, as compared to the conventional gaming machine having activated lines, it is not necessary to determine whether a winning is achieved with regard to the lines other then the center line 8c. Thus, it is possible to reduce a burden of a process required to determine whether a winning is achieved or not. Accordingly, the process of determining whether a winning is achieved or not can be rapidly carried out.

Further, in the gaming machine 1 of this embodiment, the one activated line is set in all of the base game mode, the CB game mode and the RB game mode, so that the process of determining whether a winning is achieved or not can be commonly carried out. As compared to the conventional gaming machine having activated lines, since it is not necessary to change the activated line in correspondence with the game mode, the data capacity is prevented from increasing to the utmost.

Moreover, in the gaming machine 1 of this embodiment, when a combination of symbols relating to a winning is displayed on the center line 8c, a combination of specific symbols in accordance with the combination of symbols relating to the winning is displayed on a non-activated line different from the center line 8c, e.g., top line 8b, bottom line 8d, cross-up line 8a or cross-down line 8e. For example, when a combination of symbols relating to Watermelon “Bell-Watermelon-Bell” is displayed on the center line 8c, a combination of symbols in which three Watermelon symbols are arranged, i.e., “Watermelon-Watermelon-Watermelon” is displayed on the cross-down line 8e. Accordingly, it is possible to show a player as if a prize were awarded in correspondence with the combination of specific symbols which is displayed on a non-activated line different from the center line 8c. In the above example, it is possible to show a player as if 6 medals were paid out as “Watermelon-Watermelon-Watermelon” is displayed on the cross-down line 8e. As a result of that, the player has an interest in a combination of specific symbols as well as the combination of symbols relating to the winning. Thereby, displays of combinations of symbols are prevented from being monotonous so as to enhance an interest in the game.

In addition, in the gaming machine 1 of this embodiment, displayed is a specific image, i.e., pseudo payout table on the liquid crystal display device 5, which represents a corresponding relationship between the prize in accordance with the combination of symbols relating to the winning and the combination of specific symbols in accordance with the combination of symbols relating to the winning. In other words, the player is allowed to observe the combination of specific symbols displayed on a non-activated line different from the center line 8c and the pseudo payout table, so that the player can easily perceive what kind of prize will be awarded and thus a new interest can be produced.

Further, in the gaming machine 1 of the embodiment, the liquid crystal display device 5 is provided before the reels 3L, 3C, 3R so that the symbols arranged on the reels 3L, 3C, 3R can be transparently displayed, and a predetermined effect can be carried out at the neighborhood of the rotating and stopping positions of the reels 3L, 3C, 3R. The pseudo payout table is displayed above the display windows 4L, 4C, 4R. Accordingly, when the player observes the combination of specific symbols and the corresponding pseudo payout table, an extent that a player's gaze moves can be reduced. Thus, the player's burden can be reduced and the player can more easily perceive what kind of prize will be awarded.

Besides, in the gaming machine 1 of the embodiment, since the combination of specific symbols is a combination of symbols consisting of same type of symbols, the player can easily perceive that the combination of specific symbols is displayed. Thereby, even though the combination of symbols relating to a winning is a combination of symbols consisting of different types of symbols, for example, the combination of symbols relating to Watermelon, i.e., “Bell-Watermelon-Cherry”, the player can easily perceive that a winning has been determined on the basis of the combination of specific symbols.

In addition, the gaming machine 1 of the embodiment enables the player to easily perceive the combination of specific symbols by applying a combination of different types of symbols (it may be difficult for a player to perceive this combination at first glance) as the combination of symbols relating to the winning. If a combination of same type of symbols is applied as the combination of symbols relating to the winning, the number of the combinations of symbols may be limited to the number of types of symbols. However, according to the invention, since a combination of different symbols is applied as the combination of symbols relating to the winning, the patterns of combinations become diverse and the number of combinations of symbols is increased like the embodiment of the invention.

The specific structures of elements of the gaming machine, such as the reels, the symbol display unit, the start operation detection unit, the internal winning combination determination unit, the reel rotation unit, the stop operation detection unit, the reel stop unit, the winning determination unit, the unit for awarding the prize, the image display unit, the combination of symbols relating to a winning, the combination of specific symbols, the predetermined one line, and the line different from the one line, are not limited to the above embodiment and can be arbitrarily changed.

The types of the lines displaying the combination of specific symbols are not limited to the above embodiment and may be arbitrarily changed. In the above embodiment, the symbols shown in FIG. 5 are arranged on the peripheries of the reels 3L, 3C, 3R. If “Replay-Bell-Replay” which is defined as a combination of symbols relating to a winning is displayed on the center line 8c, the combination of symbols in which three Bells are arranged, i.e., “Bell-Bell-Bell” is displayed on the cross-down line 8e. The combination of symbols relating to the winning or the symbols arranged on the reels 3L, 3C, 3R may be arbitrarily changed in correspondence with the types of a line applied as the line displaying the combination of specific symbols.

The type of the prize is not limited to the above embodiment and an arbitrary prize may be applied. For example, a specific game section, so-called replay time (RT), which increases the winning probability of Replay may be provided. In this case, an internal lottery table for RT, which has increased the range of random number defined in the winning number 11 and increased the range of random number defined in the winning number 12, may be used when the RT starts. When the value of a RT game number counter, whose initial value is 100 and value of which is subtracted by 1 every unit game, becomes 0, the RT may be ended.

Various types of prizes may be defined with regard to a combination of symbols relating a one winning. For example, as the prize defined in the combination of symbols relating to Bell 2, i.e., “Replay-Bell-Replay”, the RT may be operated in addition to the payout of 9 medals.

In addition to the display of the combination of specific symbols on another line, an internal process result of the gaming machine may be notified to show the player as if a prize were awarded. For example, when the carryover of the bonus is performed, the number of sliding symbols may be determined so that a combination of symbols, in which three Bell symbols are arranged, i.e., “Bell-Bell-Bell”, is displayed on the top line 8b. In this case, “Bell-Bell-Bell” is displayed on the top line 8b, so that the player can perceive that the carryover of the bonus is being performed.

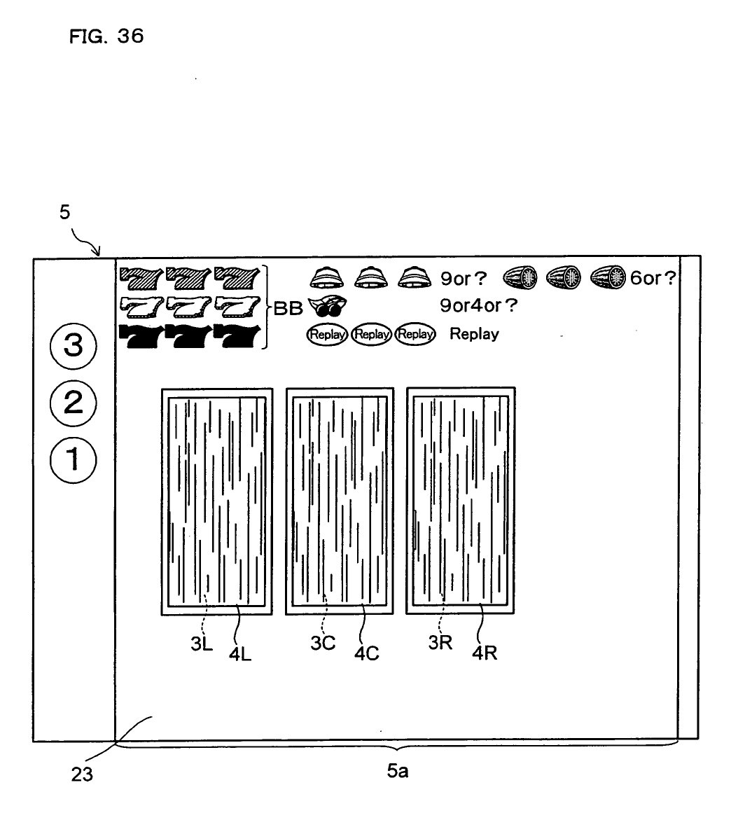

When applying the above structure, the contents of all the privileges or notifications defined regarding the combination of specific symbols may be shown in the pseudo payout table. Alternatively, some of them may be shown in the pseudo payout table. For example, the pseudo payout table shown in FIG. 36 may be displayed on the liquid crystal display unit 5a of the liquid crystal display device 5. In the pseudo payout table shown in FIG. 36, “9 or ?” is displayed with regard to the combination of symbols in which three Bells are arranged, i.e., “Bell-Bell-Bell”. This indicates that 9 pieces are paid out or the other contents are defined besides the payout of 9 pieces. Specifically, when 9 pieces are not paid out even though “Bell-Bell-Bell” is displayed on the non-activated line, another privilege or game information, for example, the determined internal winning combination, is displayed. By doing so, even though a predetermined payout is not carried out, a sense of incongruity is removed, it is possible to enable the player to have a feeling of expectation that any privilege may be paid out, and to increase the interest in the game.

In the above embodiment, the center line 8c is applied as the predetermined one line. However, the invention is not limited thereto and another line may be applied as the predetermined one line. For example, any one of the top line 8b, the bottom line 8d, the cross-up line 8a and the cross-down line 8e, or an area connecting the upper part of the left display window 4L, the central part of the center display window 4C and the upper part of the right display window 4R may be applied.

In the above embodiment, a combination of same symbols is basically applied as the combination of specific symbols. However, the invention is not limited thereto. For example, a combination of different symbols may be applied as long as the player can easily perceive it, such as “Red 7-White 7-Black 7”.

In the above embodiment, the pseudo payout table is displayed above the display windows 4L, 4C, 4R. However, the invention is not limited thereto and the position at which the pseudo payout table is displayed may be arbitrarily changed. In addition, display of the pseudo payout table may be arbitrarily changed, as long as the pseudo payout table is an image representing the corresponding relationship between the prize in accordance with the combination of symbols relating to the winning and the combination of specific symbols. For example, in the display examples shown in FIGS. 35 and 36, the pseudo payout table may be scroll-displayed from side to side.

In the above embodiment, the liquid crystal display device 5 is provided before the reels 3L, 3C, 3R. However, the invention is not limited thereto. For example, the liquid crystal display device may be mounted at a position in which it does not overlap the reels 3L, 3C, 3R, such as position below the reels 3L, 3C, 3R.

The image representing the contents of the symbol combination table, i.e., formal payout table, shown in FIG. 14, more specifically, the image representing the corresponding relationship between the combination of symbols relating to the winning and the prize in accordance with it may be displayed on the liquid crystal display device 5. In addition, the display of the corresponding relationship is not limited to an image. For example, a drawing or design representing the corresponding relationship between the combination of symbols relating to the winning and the prize in accordance with it may be provided to an upper panel or central panel of the gaming machine 1. Thereby, the player can perceive the corresponding relationship between the combination of symbols relating to the winning and the prize in accordance with it, so as to enhance the interest in the game.

In the above embodiment, the three display windows 4L, 4C, 4R are mounted to correspond to the reels 3L, 3C, 3R, respectively. However, the invention is not limited thereto. For example, a one display window may be provided. In this case, the one display window may display some, for example, three, of the symbols arranged on the peripheries of the reels 3L, 3C, 3R.

Further, the structure of the machine shown in FIGS. 1 to 5, the circuit structure shown in FIGS. 6 and 7 and the peripheral device thereof, the structures of the tables shown in FIGS 8 to 14 and 17, the structures of the storing areas of the RAM shown in FIGS. 18 to 20, the flow charts shown in FIGS. 21 to 34, the modes of the images displayed on the liquid crystal display device 5 and the like, which have been applied to the above embodiment, can be arbitrarily changed or modified without departing a spirit of the invention.

In addition to the pachi-slot machine as described in the embodiment, the invention can be applied to another gaming machine such as slot machine, video slot and the like. Additionally, the invention can be applied to a game program which pseudo-executes the operations of the above pachi-slot machine as a home gaming machine, thereby executing a game. In this case, a medium for recording the game program may include a CD-ROM, FD (flexible disk) and the other recording media.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a plurality of reels, each of which having a plurality of symbols arranged on a periphery thereof;
a symbol display unit having a plurality of symbol display areas for each of the reels, each of which areas displaying a symbol, and displaying some of the symbols respectively arranged on the peripheries of the reels, respectively;
a start operation detection unit for detecting a start operation;
an internal winning combination determination unit for determining an internal winning combination on the basis of the start operation detection carried out by the start operation detection unit;
a reel rotation unit for rotating the reels, respectively;
a stop operation detection unit for detecting a stop operation in accordance with types of the reels;
a reel stop unit for stopping rotation of the corresponding reel when the stop operation detection is carried out by the stop operation detection unit;
a winning determination unit for determining whether a winning is achieved, on the basis of a combination of symbols displayed on a one predetermined line of a plurality of lines respectively connecting one of the symbol display areas provided to each of the reels, each other, when the rotations of the reels are stopped;
a unit for awarding a prize in accordance with the combination of symbols relating to the winning and displayed at the one line, to a player, when the winning is determined by the winning determination unit; and
an image display unit for displaying an image related to a game,
wherein when the combination of symbols relating to the winning is displayed on the one line, the symbols constituting the combination of symbols relating to the winning and symbols constituting a combination of specific symbols in accordance with the combination of symbols relating to the winning are respectively arranged on the peripheries of the reels so that the combination of specific symbols is displayed on a line different from the one line, and
wherein the image display unit displays a specific image representing a corresponding relationship between the prize in accordance with the combination of symbols relating to the winning and the combination of specific symbols in accordance with the combination of symbols relating to the winning.

2. A gaming machine comprising:
a plurality of reels, each of which having a plurality of symbols arranged on a periphery thereof;
an image display unit provided just before the reels, viewing from a front side, having a plurality of symbol display areas for each of the reels, each of which areas displaying a symbol, and capable of transparently displaying some of the symbols respectively arranged on the peripheries of the reels, respectively;
a start operation detection unit for detecting a start operation;
an internal winning combination determination unit for determining an internal winning combination based on the start operation detection carried out by the start operation detection unit;
a reel rotation unit for rotating the reels, respectively;
a stop operation detection unit for detecting a stop operation in accordance with types of the reels;
a reel stop unit for stopping rotation of the corresponding reel when the stop operation detection is carried out by the stop operation detection unit;
a winning determination unit for determining whether a winning is achieved, on the basis of a combination of symbols displayed on a one predetermined line of a plurality of lines respectively connecting one of the symbol display areas provided to each of the reels, each other, when the rotations of the reels are stopped; and
a unit for awarding a prize in accordance with the combination of symbols relating to the winning and displayed at the one line, to a player, when the winning is determined by the winning determination unit,
wherein when the combination of symbols relating to the winning is displayed on the one line, the symbols constituting the combination of symbols relating to the winning and symbols constituting a combination of specific symbols in accordance with the combination of symbols relating to the winning are respectively arranged on the peripheries of the reels so that the combination of specific symbols is displayed on a line different from the one line, and
wherein the image display unit displays a specific image representing a corresponding relationship between the prize in accordance with the combination of symbols relating to the winning and the combination of specific symbols in accordance with the combination of symbols relating to the winning on a neighborhood of the symbol display areas.

3. The gaming machine according to claim 1, wherein the combination of specific symbols is a combination of symbols consisting of same type of symbols.
